(19) United States
(12) Patent Application Publication
(10) Pub. No.: US 2002/0057694 A1
(43) Pub. Date: May 16, 2002

(54) SOURCE INFORMATION CONTROLLING METHOD, SOURCE INFORMATION RECEIVING APPARATUS AND SOURCE INFORMATION TRANSMITTING APPARATUS, AND SOURCE INFORMATION TRANSMITTING-RECEIVING SYSTEM

(76) Inventor: TOSHIYUKI KAMO, KANAGAWA (JP)

Correspondence Address: HELFGOTT & KARAS, EMPIRE STATE BUILDING, 60TH FLOOR, NEW YORK, NY, 101180110

(21) Appl. No.: 08/901,315

(22) Filed: Jul. 28, 1997

(30) Foreign Application Priority Data
Sep. 10, 1996 (JP) HEI 08-239610
Feb. 24, 1997 (JP) HEI 09-039568

(51) Int. Cl. H04L 12/56

(52) U.S. Cl. 370/395.2; 370/395.3

(57) ABSTRACT

In a source information controlling method, a source information receiving apparatus generates control information to control source information transmitted from a source information transmitting apparatus, accommodates the control information in a fixed length cell for control information and outputs the fixed length cell for control information through the same connection as a connection for transmitting the source information, whereas the source information transmitting apparatus accommodates the source information in a fixed length cell for source information on the basis of the control information transmitted from the source information receiving apparatus and transmits the fixed length cell for source information to the source information receiving apparatus.

### BACKGROUND OF THE INVENTION

The present invention relates to a source information controlling method, a source information receiving apparatus and a source information transmitting apparatus, and a source information transmitting-receiving system suitable for use upon moving picture information transmission such as VOD (Video On Demand) service or the like.

For these years, there have been developed a lot of application techniques to improve quantity, quality, etc. of services provided to customers by utilizing ATM (Asynchronous Transfer Mode) in each development organization.

For instance, a VOD (Video On Demand) service or the like utilizes broadband characteristics of ATM so as to transmit not only voice information but also moving picture information as source information, which has a system configuration as shown in FIG. 34, for example.

FIG. 34 is a block diagram showing a source information transmitting-receiving system 100 which can provide the above VOD service and the like. The source information transmitting-receiving system 100 shown in FIG. 34 has a server 101, a client 102, an ATM network 103 and a session controlling unit 104.

The server 101 provides desired moving image information (source information) through a connection (Video) for source information in the ATM network 103 to the client 102. The source information is transmitted to the client 102 in a format of ATM cell.

The client 102 functions as a user terminal, which regenerates the source information received over the ATM network 103 from the server 101. The client 102 receives the source information having been controlled on the basis of control information transmitted from the client 102.

In concrete, the client 102 transmits control information directing to switch a channel of, shuttle, rewind, etc., image information through a connection (U-U control) 106 for control information, which is different from the above connection for the source information 105, to the server 101, whereby the server 101 transmits desired source information according to the control information to the client 102.

In other words, the server 101 functions as a center which conducts a centralized control on source information that should be provided to the client 102. The client 102 freely gives a direction relating to the source information provided from the server 101 to control the same.

The session controlling unit 104 manages a state of connection (a state of utilization of the VOD service) of the client 102 as a user terminal connected to the server 101 over the ATM network 103.

Among the server 101, the client 102 and the session controlling unit 104 mentioned above, there are set four connections 105 through 108 described below via the ATM network 103 and a UNI (User Network Interface)

The connection 105 transmits the source information in unidirectional communication from the server 101 to the client 102. The connection 106 exchanges control information about the source information or another control information in bidirectional communication between the server 101 and the client 102.

The connection 107 is a connection for controlling a signal (for line switching) between the client 102 and the server 101, which is possessed by a client or a server as an ordinary line switching terminal accommodated in the network.

The connection 108 is a connection among the server 101, the client 102 and the session controlling unit 104. By using the connection 108, it is possible to authenticate the server 101 and the client 102.

Incidentally, structures of the above connections 105, 107 and 108 are logical so that all the connections 105, 107 and 108 may be accommodated in the server 101 and the client 102.

With the above structure, the source information transmitting-receiving system 100 shown in FIG. 34 transmits (provides) source information such as video information and the like from the server 101 to the client 102 through the connection 105 for source information.

On the other hand, the client 102 transmits control information directing to switch a channel of, shuttle, rewind, etc., the image information to the server 101 through the connection 106 for control information set separately from the connection 105 for source information, whereby the server 101 transmits (provides) desired source information according to the control information to the client 102.

However, in the above source information transmitting-receiving system 100 shown in FIG. 34, one client 102 needs to occupy a plurality of network resources when receiving the VOD service since different connections are used as the connection for source information 105 and the connection 106 for control information.

For this, if tens of thousands of subscribers use the VOD service in the future, it would be necessary for the network's side to prepare resources for the connections for source information and the connections for control information, which reduces an efficiency of utilization of the network resources.

However, the control information is generally transmitted through the above connection 106 for control information only when a subscriber (service user) on the side of the client 102 wants to control the source information provided from the server 101. It is obvious that a quantity of information flowing through the above connection 106 for control information is small as compared with a maximum quantity of information that one connection can transmit.

Therefore, the control information in the above connection 106 for control information does not require a band in such a degree that one connection is set separately from the above connection 105 for source information. If the connections 105 and 106 are separately set, it becomes impossible to efficiently use the network resources.

Further, in consideration of a burden on a subscriber on the side of the client 102, a network cost increases since the connection 106 for control information is used along with the above connection 105 for source information. As a result, a burden on the subscriber increases as compared with a frequency of utilization of the network.

Still further, a subscriber on the side of the client 102 needs to establish a plurality of the connections 105 and 106 when using the service, which increases a process time necessary to establish the connections, thus increases a time period until moving image data is provided from the server 101. This causes poor service to the user.

### SUMMARY OF THE INVENTION

In the light of the above problems, an object of the present invention is to provide a source information controlling method, a source information receiving apparatus and a source information transmitting apparatus, and a source information transmitting-receiving system, in which establishment of an exclusive connection is unnecessary when a subscriber transmits control information, whereby it is possible to efficiently use the network resource, decrease the network cost on the subscriber and improve the service.

The present invention therefore provides a source information controlling method comprising the steps of accommodating source information in a fixed length cell for source information and transmitting the fixed length cell for source information when transmitting the source information from a source information transmitting apparatus to a source information receiving apparatus, generating control information to control the source information transmitted from the source information transmitting apparatus by the source information receiving apparatus, accommodating the control information in a fixed length cell for control information and transmitting the fixed length cell for control information through the same connection as a connection for transmitting the source information, and transmitting the source information from the source information transmitting apparatus to the source information receiving apparatus through the connection on the basis of the control information transmitted from the source information receiving apparatus.

In the above case, it is possible to use a maintenance operation cell for maintenance and operation upon transmitting data between the source information transmitting apparatus and the source information receiving apparatus as the fixed length cell for control information. It is alternatively possible to use a fixed length cell including the control information generated in the source information receiving apparatus in a data region thereof as the above fixed length cell for control information.

Further, it is possible to set an exclusive higher layer which can handle information for controlling the source information received from the above source information transmitting apparatus, besides it is possible to use a fixed length cell generated by the higher layer as the fixed length cell for control information.

The present invention further provides a source information controlling method comprising the steps of accommodating source information in a fixed length cell for source information and transmitting the fixed length cell for source information when transmitting the source information from a source information transmitting apparatus to a source information receiving apparatus over a line switching network, generating control information to control the source information received from the source information transmitting apparatus in the source information receiving apparatus, accommodating the control information in a signal for line switching and outputting the signal for line switching to the source information transmitting apparatus, and transmitting the source information from the source information transmitting apparatus to the source information receiving apparatus on the basis of the control information accommodated in the signal for line switching transmitted from the source information receiving apparatus.

The present invention still further provides a source information receiving apparatus for receiving source information from a source information transmitting apparatus with a fixed length cell as an information transmitting medium comprising a control information generating-transmitting unit for generating control information to control the source information transmitted from the source information transmitting apparatus, accommodating the control information in a fixed length cell for control information and transmitting the fixed length cell for control information through the same connection as a connection for transmitting the source information.

In the above case, the fixed length cell for control information may be configured with a fixed length cell in a format different from a format of the fixed length cell for source information. Alternatively, the fixed length cell for control information may be configured with a maintenance and operation cell used for maintenance and operation when data is transmitted and received between the above source information transmitting apparatus and the source information receiving apparatus.

The maintenance and operation cell used as the fixed length cell for control information may be configured with an exclusive maintenance operation cell for controlling the source information. Alternatively, the maintenance operation cell used as the fixed length cell for control information may be configured with a maintenance operation cell including another maintenance operation information.

Still further, the fixed length cell for control information may be configured with a fixed length cell including the control information generated by the above source information receiving apparatus in a data region thereof.

The source information receiving apparatus may further have a higher layer setting unit for setting an exclusive higher layer which can handle information for controlling the source information received from the source information transmitting apparatus, besides the fixed length cell for control information may be configured with a fixed cell generated by the higher layer.

The present invention still further provides a source information receiving apparatus for receiving source information from a source information transmitting apparatus over a line switching network with a fixed length cell as an information transmitting medium comprising a line switching signal outputting unit for generating control information to control the source information received from the source information transmitting apparatus, accommodating the control information in a signal for line switching and outputting the signal for line switching from the source information receiving apparatus to the source information transmitting apparatus.

In the above case, the signal for line switching outputted by the line switching signal outputting unit may be configured with an exclusive message signal for controlling the source information, or with a signal including another message signal.

The present invention still further provides a source information transmitting apparatus for transmitting source information to a source information receiving apparatus with a fixed length cell as an information transmitting medium comprising a source information transmitting unit for transmitting the source information to the source information receiving apparatus through a connection on the basis of control information received through the same connection as the connection for transmitting the source information from the source information receiving apparatus.

The present invention still further provides a source information transmitting apparatus for transmitting source information to a source information receiving apparatus with a fixed length cell as an information transmitting medium comprising a source information transmitting unit for transmitting the source information to the source information receiving unit on the basis of control information accommodated in a signal for line switching transmitted from the source information receiving apparatus.

The present invention still further provides a source information transmitting-receiving system comprising a source information transmitting apparatus for transmitting source information with a fixed length cell as an information transmitting medium and a source information receiving apparatus for receiving the source information from the source information transmitting apparatus, the source information receiving system including a control information generating-transmitting unit for generating control information to control the source information transmitted from the source information transmitting apparatus, accommodating the control information in a fixed length cell for control information and outputting the fixed length cell for control information through the same connection as a connection for transmitting the source information, and the source information transmitting apparatus including a source information transmitting unit for transmitting the source information to the source information receiving apparatus through the connection on the basis of the control information transmitted from the control information generating-transmitting unit.

The present invention still further provides a source information transmitting-receiving system comprising a source information transmitting apparatus for transmitting source information with a fixed length cell as an information transmitting medium and a source information receiving apparatus for receiving the source information from the source information transmitting apparatus over a line switching network, the source information receiving apparatus including a line switching signal outputting unit for generating control information to control the source information received from the source information transmitting apparatus, accommodating the control information in a signal for line switching and outputting the signal for line switching from the source information receiving apparatus to the source information transmitting apparatus, and the source information transmitting apparatus including a source information transmitting unit for transmitting the source information to the source information receiving apparatus on the basis of the control information accommodated in the signal for line switching transmitted from the line switching signal outputting unit.

According to this invention, the control information generating-transmitting unit or the line switching signal outputting unit of the source information receiving apparatus generates and outputs control information for controlling the source information, whereas the source information transmitting unit of the source information transmitting apparatus transmits the source information based on the control information transmitted from the source information receiving apparatus to the source information receiving apparatus through the same connection for the control information. In consequence, only one connection is required to be set between the source information transmitting apparatus and the source information receiving apparatus for one subscriber. As a result, it is possible to efficiently use the network resource, and largely decrease a burden (charge) on the subscriber.

When the connection is established, it becomes unnecessary to establish a plurality of connections so that a time required from when the user start using to when the connection is established may be shortened. This largely contribute to an improvement of the service.

### BRIEF DESCRIPTION OF THE DRAWINGS

FIGS. 1 and 2 are block diagrams showing aspects of this invention;

FIG. 3 is a block diagram showing a VOD system as a source information transmitting-receiving system according to the present embodiment of this invention;

FIG. 4 is a block diagram showing an ATM switch in the source information transmitting-receiving system according to the present embodiment of this invention;

FIG. 5 is a diagram showing a tagging unit in the ATM switch according to the present embodiment of this invention;

FIG. 6 is a block diagram showing a server when an attention is paid to a function to transmit source information according to a first embodiment of this invention;

FIG. 7 is block diagram showing a line terminating unit of the server according to the first embodiment of this invention;

FIG. 8 is a block diagram showing a client when an attention is paid on a function to receive the source information and a function to transmit control information used to control the source information according to the first embodiment of this invention;

FIG. 9 is a block diagram showing a line terminating unit of the client according to the first embodiment of this invention;

FIG. 10 is a diagram showing a cell format of an OAM cell for controlling the source information according to the first embodiment of this invention;

FIG. 11 is a diagram showing control information configured with a source switching information region and a source controlling information region according to the first embodiment of this invention;

FIGS. 12 through 19 are diagrams for illustrating a modification of the first embodiment of this invention;

FIG. 20 is a block diagram showing a line terminating unit of the server according to a second embodiment of this invention;

FIG. 21 is a block diagram showing a line terminating unit of the client according to the second embodiment of this invention;

FIG. 22 is a diagram showing a cell format of an ATM cell for controlling the source information according to the second embodiments;

FIG. 23 is a block diagram showing a line terminating unit of the server according to a third embodiment of this invention;

FIG. 24 is a block diagram showing a line terminating unit of the client according to the third embodiment of this invention;

FIG. 25 is a diagram showing an exclusive higher layer being able to handle the control information for controlling the source information according to the third embodiment;

FIG. 26 is a block diagram showing a line terminating unit of the server according to a fourth embodiment of this invention;

FIG. 27 is a block diagram showing a line terminating unit of the client according to the fourth embodiment of this invention;

FIG. 28 is a signal sequence diagram showing a procedure to set/release a connection used to transmit and receive the source information according to the fourth embodiment of this invention;

FIG. 29 is a signal sequence diagram showing a transmission mode of a source controlling signal in a state where the server can provide the source information to the client according to the fourth embodiment of this invention;

FIG. 30 is a diagram showing a signal frame produced from a general message signal for line switching according to the fourth embodiment of this invention;

FIG. 31 is a diagram showing an exclusive control signal frame for controlling the source information produced on the basis of source controlling information according to the fourth embodiment of this invention;

FIG. 32 is a diagram showing an essential part of the exclusive control signal frame for controlling the source information according to the fourth embodiment of this invention;

FIG. 33 is a diagram showing another essential part of the exclusive control signal frame for controlling the souce information according to the fourth embodiment of this invention; and

FIG. 34 is a diagram showing a system configuration of a VOD service.

### DESCRIPTION OF THE PREFERRED EMBODIMENTS

(a) Description of Aspects of the Invention

Now, aspects of this invention will be described with reference to the drawings.

FIG. 1 is a block diagram showing an aspect of this invention. In FIG. 1, reference numeral 1 denotes a source information transmitting-receiving system. The source information transmitting-receiving system 1 has a source information transmitting apparatus 2 for transmitting source information with a fixed length cell as an information transmitting medium, and a source information receiving apparatus 3 for receiving the source information from the source information transmitting apparatus 2. The source information transmitting apparatus 2 has a source information transmitting unit 2A, whereas the source information receiving apparatus 3 has a control information generating-transmitting unit 3A.

The control information generating-transmitting unit 3A generates control information to control the source information transmitted from the source information transmitting apparatus 2, accommodates the control information in a fixed length cell for control information and outputs the fixed length cell for control information through the same connection as a connection for transmitting the source information.

The source information transmitting unit 2A transmits the source information to the source information receiving apparatus 3 through the above connection on the basis of the control information transmitted from the control information generating-transmitting unit 3A.

The above fixed length cell for control information may be configured with a fixed length cell in a format different from a format of the fixed length cell for source information. Further, the above fixed length cell for control information may be configured with a maintenance operation cell for maintenance and operation upon transmitting and receiving data between the source information transmitting apparatus 2 and the source information receiving apparatus 3.

In the above case, the maintenance operation cell used as the fixed length cell for control information may be configured with an exclusive maintenance operation cell for controlling the above control information, or the maintenance operation cell used as the fixed length cell for control information may be configured with a maintenance operation cell including another maintenance operation information.

Further, the fixed length cell for control information may be configured with a fixed length cell including the control information generated by the above source information receiving apparatus 3 in a data region thereof.

The source information receiving apparatus 3 may have a higher layer setting unit for setting an exclusive higher layer which can handle information for controlling the source information received from the source information transmitting apparatus 2, besides the fixed length cell for control information may be configured with a fixed length cell generated by the higher layer.

According to this invention shown in FIG. 1, the source information is accommodated in the fixed length cell for source information when transmitted from the source information transmitting apparatus 2 to the source information receiving apparatus 3.

The control information generating-transmitting unit 3A of the source information receiving apparatus 3 generates the control information for controlling the source information transmitted from the source information transmitting apparatus 2, accommodates the control information in the fixed length cell for control information and outputs the fixed length cell for control information through the same connection as a connection for transmitting the source information. On the other hand, the source information transmitting unit 2A of the source information transmitting apparatus 2 transmits the source information to the source information receiving apparatus 3 through the above connection on the basis of the control information transmitted from the source information receiving apparatus 3.

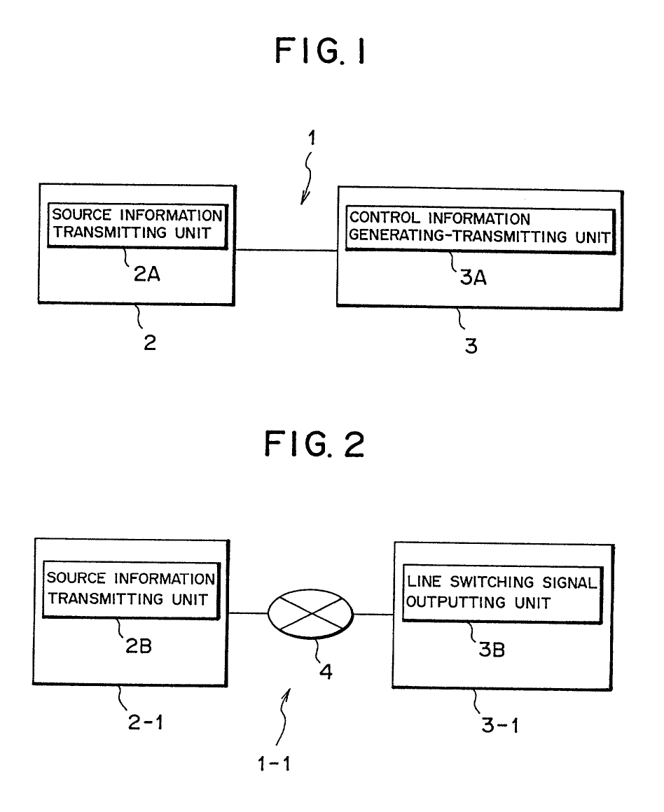

FIG. 2 is a block diagram showing another aspect of this invention. In FIG. 2, reference numeral 1-1 denotes a source information transmitting-receiving system. The source information transmitting-receiving apparatus 1-1 has a source information transmitting apparatus 2-1 for transmitting source information with a fixed length cell as an information transmitting medium, and a source information receiving apparatus 3-1 for receiving the source information from the source information transmitting apparatus 2-1 over a line switching network 4.

The source information receiving apparatus 3-1 has a line switching signal outputting unit 3B for generating control information for controlling the source information received from the source information transmitting apparatus 2-1, accommodating the control information in a signal for line switching, and outputting the signal for line switching from the source information receiving apparatus 3-1 to the source information transmitting apparatus 2-1.

The source information transmitting apparatus 2-1 has a source information transmitting unit 2B for transmitting the source information to the source information receiving apparatus 3-2 on the basis of the control information accommodated in the signal for line switching transmitted from the line switching signal outputting unit 3B.

The signal for line switching outputted by the line switching signal outputting unit 3B may be configured with an exclusive message signal for controlling the above source information, or with a signal including another message signal.

According to this invention shown in FIG. 2, the source information is accommodated in the fixed length cell for source information and transmitted when transmitted from the source information transmitting apparatus 2-1 to the source information receiving apparatus 3-1 over the line switching network.

The line switching signal outputting unit 3B of the source information receiving apparatus 3-1 generates the control information for controlling the source information received from the source information transmitting apparatus 2-1, accommodates the control information in the signal for line switching and outputs the signal for line switching to the source information transmitting apparatus 2-1. On the other hand, the source information transmitting unit 2B of the source information transmitting apparatus 2-1 transmits the source information to the source information receiving apparatus 3 on the basis of the control information accommodated in the signal for line switching transmitted from the source information receiving apparatus 3-1.

(b) Description of a First Embodiment of the Invention

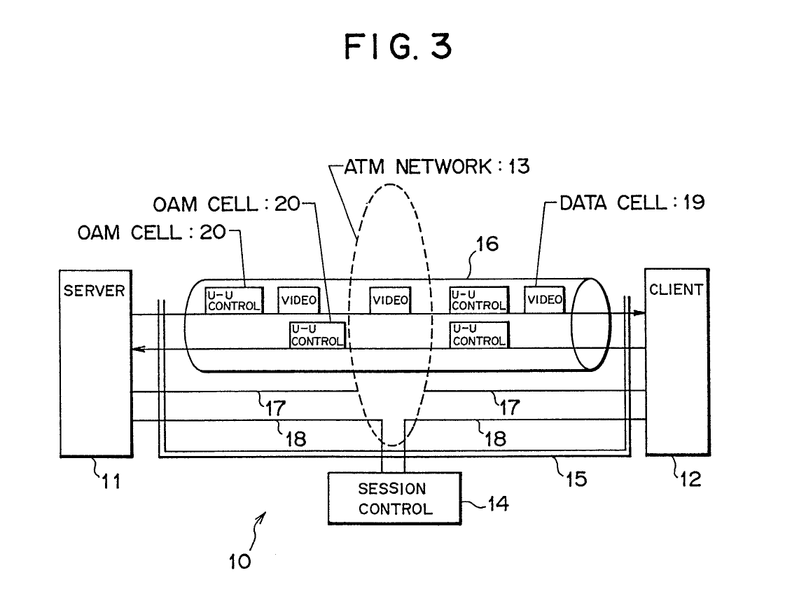

FIG. 3 is a block diagram showing a VOD system as a source information transmitting-receiving system according to a first embodiment of this invention. The VOD system 10 shown in FIG. 3 can transmit not only voices but also image information such as moving image information and the like as source information by using broadband characteristics of ATM, in which a server 11, a client (STB) 12 as a user terminal and a session controlling unit 14 are connected with each other over an ATM network 13.

Namely, the VOD system 10 can provide video information (image information and voice information) such as movie, sports, other programs, etc. as source information from the server 11 to the client 12 by designating a channel by a user.

The server 11 has a function as a source information transmitting apparatus which transmits source information with ATM cells (fixed length cells) as an information transmitting medium. The server 11 can transmit image information, voice information and the like as the source information.

The client 12 has a function as a source information receiving apparatus which receives source information from the server 11. In addition, the client 12 regenerates the source information received from the server 11, besides being able to conduct controls such as channel switching, shuttling, rewinding, etc., in the client 12 on the source information transmitted from the server 11, as will be described later.

Namely, the server 11 can transmit desired source information to the client 12 according to the control information transmitted from the client 12.

In other words, the server 11 functions as a center which intensively controls source information that should be provided to the client 12 as a user terminal. The client 12 can freely control the source information provided from the server 11.

The ATM network 13 has an ATM switch or the like which switches an ATM cell flowing in over a transmission line to a desired route on the basis of information described in a header portion of the ATM cell.

The session controlling unit 14 shown in FIG. 3 manages a state of connection (a state of utilization of the VOD service) of the client 12 as a user terminal connected to the server 11 over the ATM network 13.

Among the server 11, the client 12 and the session controlling unit 14 mentioned above, there are set connections 16 through 18 described below via the ATM network 13 and a, UNI (User Network Interface) 15.

The connection 16 is used to connect the server 11 to the client 12. Through the connection 16, the server 11 can transmit source information to the client 12, besides the client 12 can transmit control information to control the source information to the server 12.

The above source information is accommodated in general data cells 19 as fixed length cells for source information, then transmitted. On the other hand, the control information used to control the source information is accommodated in a U-U control cell (OAM cell; Operation, Administration and Maintenance cell) 20 described later, then transmitted. The OAM cell 20 is used for maintenance and operation when data is transmitted and received between the server 11 and the client 12.

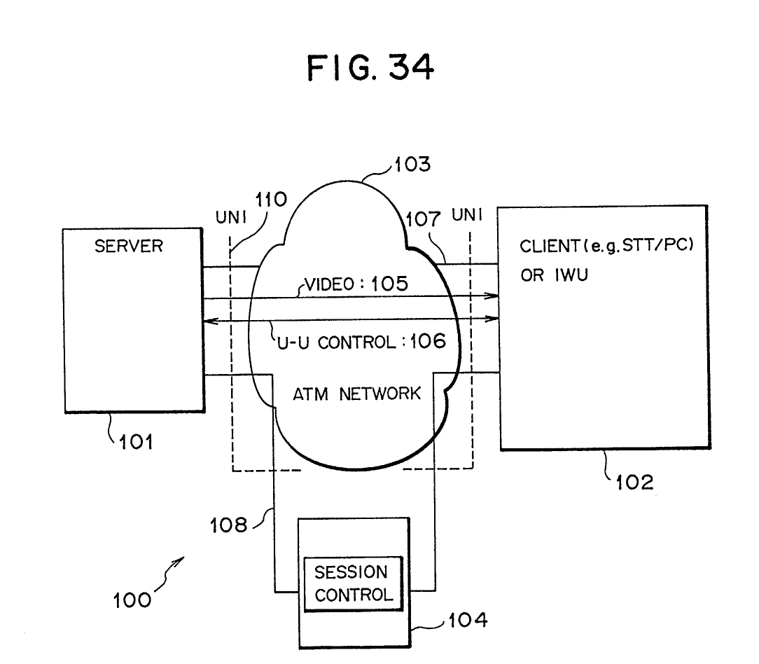

The connection 16 functions as the connection 105 for source information and the connection 106 for control information shown in FIG. 34. Namely, the connection for source information and the connection for control information are integrated into one connection to realize the functions of these connections.

The connection 17 is a connection for signal control between the client 12 and the server 11, which is possessed by the client 12 or the server 11 as a general line switching terminal accommodated in the ATM network 13.

The connection 18 is a connection among the server 11, the client 12 and the session controlling unit 14. The server 11 and the client 12 are authenticated by using the connection 18, whereby a state of utilization of the VOD system 10 can be managed.

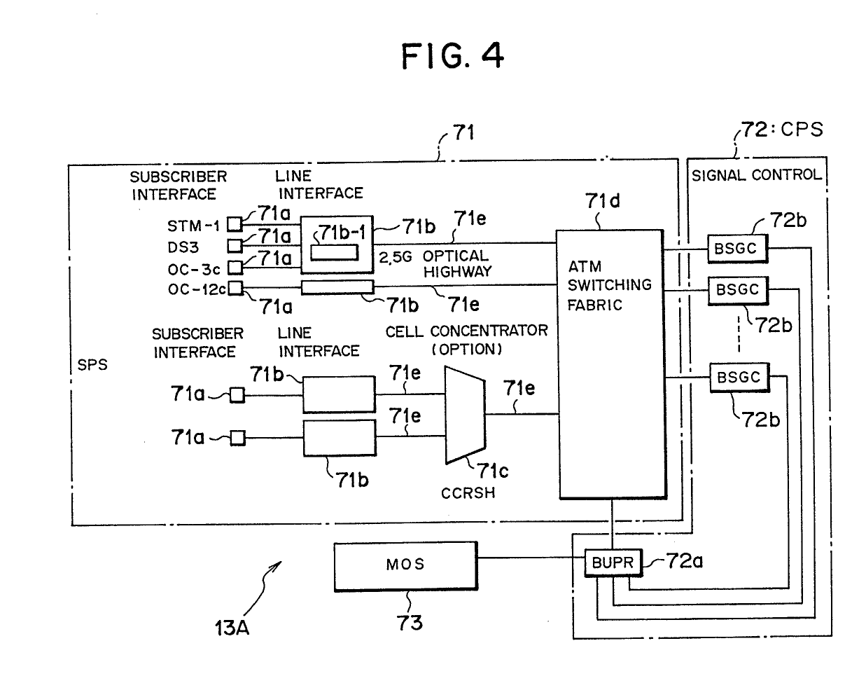

An ATM switch 13A configuring the above ATM network 13 has a structure shown in FIG. 4, for example.

The ATM switch 13A shown in FIG. 4 has an SPS (Signal Path Subsystem) 71, a CPS (Central Processing Subsystem) 72 and a MOS (Maintenance and Operations Subsystem) 73.

The SPS 71 has a subscriber interface 71a, a line interfacing apparatus 71b, a cell concentrator (CCRSH) 71c and a ATM switching fabric 71d.

The subscriber interface 71a interfaces an ATM cell transmitted through various lines (STM-1, DS3, OC-3C, OC-12C, for example) from the subscriber's side. The line interfacing apparatus 71b terminates a traffic in a user-network interface or a network node interface, and outputs the terminated ATM cell to the ATM switching fabric 71c via an optical highway 71e having a transfer rate of 2.5 Gbps.

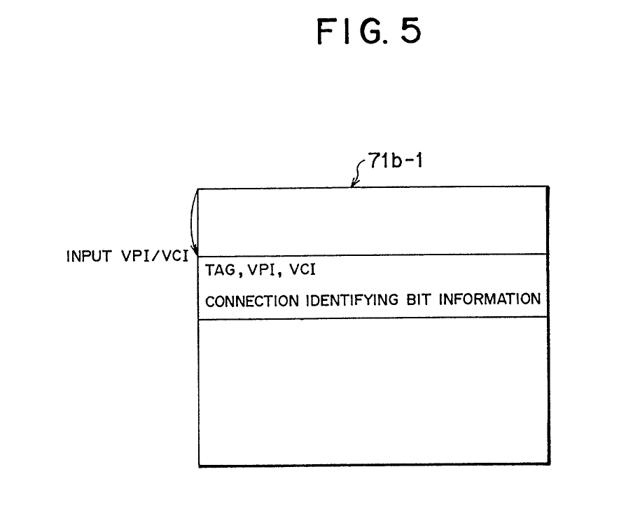

The line interfacing apparatus 71b has a tagging unit (VCC; Virtual Channel Converter) 71b-1 as shown in FIG. 5, for example.

The tagging unit 71b-1 stores information (TAG) about a routing tag showing an output VPI (Virtual Path Identifier)/VCI (Virtual Channel Identifier) and a route in the ATM switching fabric 71d in the rear stage with an input VPI/VCI written in the header portion of the ATM cell fed from the subscriber interface 71a as an address.

In other words, when an ATM cell flows into the tagging unit 71b-1 from the subscriber interface 71a, the tagging unit 71b-1 extracts the output VPI/VCI and a routing tag with the input VPI/VCI written in the header portion of the ATM cell as address information, changes the input VPI/VCI of the header information to the output VPI/VCI, besides attaching the routing tag and outputting it to the ATM switching fabric 71d in the rear stage.

The above tagging unit 71b-1 also stores information used to discriminate whether a relevant connection is VCC (Virtual Channel Connection) or VPI (Virtual Path Connection) according to VPI/VCI of an inputted ATM cell as bit information. The tagging unit 71b-1 can tag the above bit information to the header portion of the ATM cell along with the above routing tag.

The above VCC is a connection used to monitor a band of each VP/VC in the MOS 73, whereas VPC is a connection used to monitor a band of each VP in the MOS 73.

If a connection used when the server 11 and the client 12 communicate with each other is VCC, a functioning unit described later which terminates an ATM layer in the server 11, the client 12 and the ATM switch 13A discriminates a data cell (user cell) from an OAM cell according to a PT (Payload type; 3 bits length) number.

In concrete, when a user cell is generated, any number among “000” through “011” is given as the PT. When an OAM cell is generated, “100” or “101” is given as the PT. Similarly, when an OAM flowing into is identified, the OAM cell is discriminated from a user cell if the PT is any number among “000” through “011”. If the PT is “100” or “101”, the ATM cell is identified as an OAM cell.

If the connection 16 is VPC, the functioning unit which terminates the ATM layer in the server 11, the client 12 and the ATM switch 13A discriminates a data cell (user cell) from an OAM cell using a VCI (16 bits length) number.

In concrete, when an OAM cell is generated, “3” or “4” in decimal code representation is given as VCI. When a user cell is generated, any number among “32” through “4096” in decimal code representation is given. Similarly, when an ATM cell flowing into is discriminated, the ATM cell is recognized as an OAM cell if the VCI is “3” or “4” in decimal code representation. If VCI is any number among “32” through “4096”, the ATM cell is recognized as a user cell.

The cell concentrator 71c shown in FIG. 4 concentrates traffics from the line interfacing apparatus 71b, and outputs them to the ATM switching fabric 71d. The ATM switching fabric 71d switches an ATM cell flowing from the line interfacing apparatus 71b or the cell concentrator 71c to a desired route.

The CPS 72 has a BUPR (Broadband Uniprocessor) 72a and a BSGC (Broadband Signaling Controller) 72b as a signal controlling apparatus.

The BUPR 72a sets IPL (Initial Program Loading) of a system and maintains a system configuration to set a permanent virtual connection (PVC) or a switched virtual connection (SVC). The BSGC 72b signals when an SVC function is applied.

The MOS 73 is connected to the BUPR 72a to maintain and operate the whole ATM switch 13A through supervising an alarm or a status, which has a testing apparatus, a maintenance interface, etc., not shown.

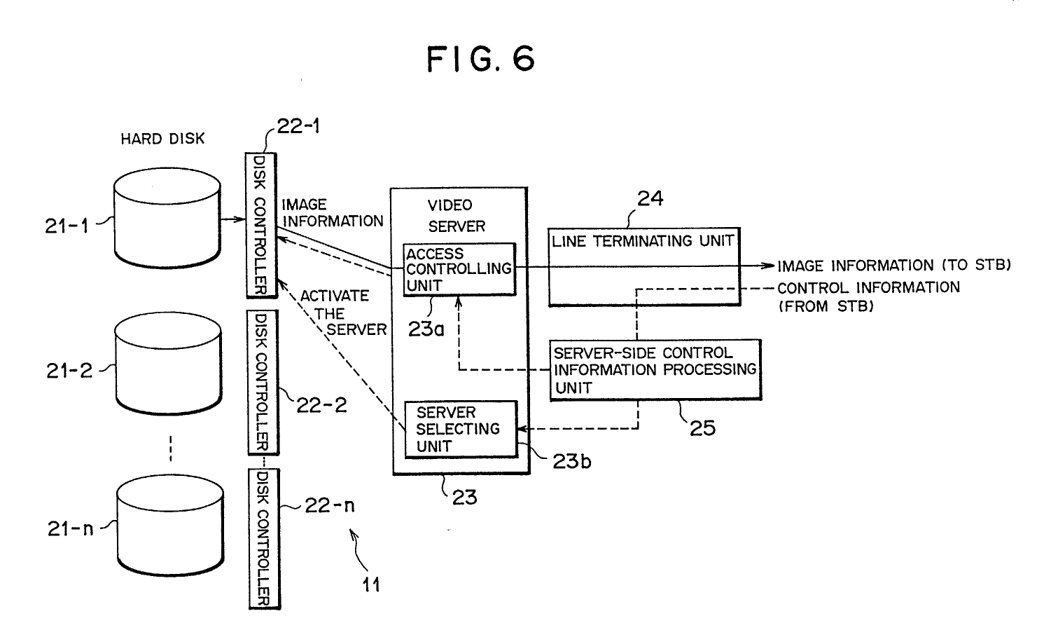

The above server 11 has in detail a structure as shown in FIG. 6, when an attention is paid on a function to transmit the source information. In FIG. 6, the functioning unit connected to the connection 17 and the connection 18 is omitted.

Namely, the server 11 has, as shown in FIG. 6, hard disks 21-1 through 21-n, a disk controlling unit 22-1 through 22-n, a video server 23, a line terminating unit 24 and a server-side control information processing unit 25.

Each of the hard disks 21-1 through 21-n stores source information that should be provided to the client 12. In each of the hard disks 21-1 through 21-n, different source information is stored.

The disk controlling units (Disk Controller) 22-1 through 22-n take out source information data stored in the respective hard disks 21-1 through 21-n (source information stored in the hard disk 21-1 in the case of FIG. 6).

The line terminating unit 24 terminates the connection 16 set between the server 11 and the client 12 over the ATM network 13. In concrete, the line terminating unit 24 is inputted desired source information data taken out by accessing the hard disk 21-1, 21-2, . . . or 21-n by the corresponding disk controller 22-1, 22-2, . . . 22-n via the video server 23, accommodates the source information data in ATM cells to transmit it to the client (STB) 12 through the connection 16, besides receiving information used to control the source information fed from the client 12 through the above connection 16.

The server-side control information processing unit 25 is inputted information used to control the source information transmitted from the client 12 through the line terminating unit 24 to analyze this control information.

The video server 23 controls source information data that should be provided to the client 12 on the basis of a result of analysis on the control information obtained in the server-side control information processing unit 25, which has an access controlling unit 23a and a server selecting unit 23b.

The access controlling unit 23a controls a transfer rate of the source information taken out by the disk controlling units 22-1, 22-2, . . . or 22-n to the client 12 on the basis of a result of analysis on the control information by the above server-side control information processing unit 25 when receiving, from the client 12, a direction to shuttle or rewind, etc., the source information being now provided. By virtue of the access controlling unit 23a, it is possible to provide source information according to a control to shuttle, rewind, etc., given by the above client 12.

When receiving a direction to activate the server 11 because of a channel switching or channel designation from the client 12, the server selecting unit 23b activates the hard disk 21-1, 21-2, . . . or 21-n (the hard disk 21-1 in the case of FIG. 6) in which source information data of a relevant channel is stored on the basis of a result of analysis on control information obtained by the above server-side control information processing unit 25, and directs the corresponding disk controlling unit 22-1, 22-2, . . . or 22-n to transfer the source information.

Accordingly, the hard disks 21-1 through 21-n, the disk controlling units 22-1 through 22-n, the server-side control information processing unit 25 and the video server 23 mentioned above realize a function as a source information transmitting unit which transmits the source information to the client through the connection 16 on the basis of control information transmitted from the client 12.

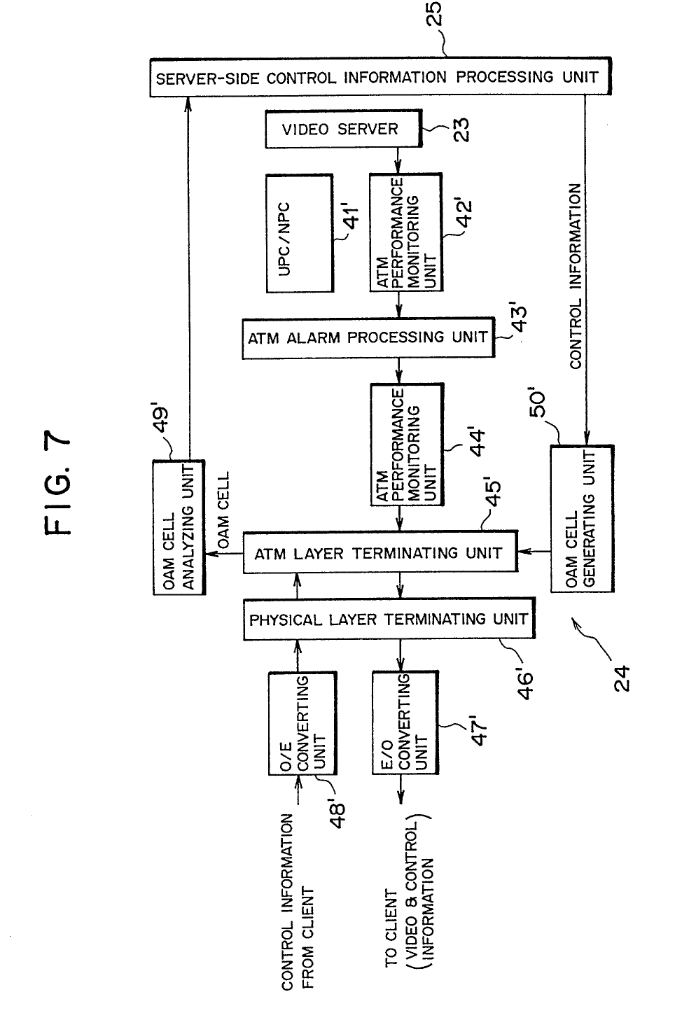

The line terminating unit 24 of the above server 11 has, as shown in FIG. 7 in detail, a cell flow rate controlling unit (UPC/NPC) 41′, an ATM performance monitoring unit 42′, an ATM alarm processing unit 43′, an ATM performance monitoring unit 44′, an ATM layer terminating unit 45′, a physical layer terminating unit 46′, an E/O (Electric/Optic) converting unit 47′, an O/E (Optic/Electric) converting unit 48, an OAM cell analyzing unit 49′ and an OAM cell producing unit 50′.

The cell flow rate controlling unit (UPC/NPC) 41′ measures a parameter of a traffic. The ATM performance monitoring units 42′ and 44′ process a performance management cell as an OAM cell.

The ATM alarm processing unit 43′ is inputted transmit data from the ATM performance monitoring unit 42′ to process a fault management cell and an activation/deactivation cell as OAM cells.

The ATM layer terminating unit 45′ is inputted data from the ATM performance monitoring unit 44′ to generate a data cell as an ATM cell, inserts an OAM cell fed from the OAM cell producing unit 50′ described later to a flow of the generated data cells, and sends the cells to the physical layer terminating unit 46′, besides extracting a data cell as an ATM cell and an OAM cell (maintenance and operation cell) from received cell data fed from the physical layer terminating unit 46′.

The physical layer terminating unit 46′ conducts an overhead process, a SONET (Synchronous Optical Network) terminating process or an SDH (Synchronous Digital Hierarchy) terminating process on a transmit cell data fed from the ATM layer terminating unit 45′ to send it out to the E/O converting unit 47′, besides conducting the overhead process, the SONET (Synchronous Optical Network) terminating process or the SDH (Synchronous Digital Hierarchy) terminating process on a received cell data fed from the O/E converting unit 48′ to send it out to the ATM layer terminating unit 45′.

The E/O converting unit 47′ converts an electric signal as the transmit cell data (OAM cell including control information along with data cell including video information as source information) fed from the physical layer terminating unit 46′ into an optical signal, and transmits the optical signal as a transmit signal to the client 12 through the connection 16 in the ATM network 13.

The O/E converting unit 48′ converts an optical signal as received cell data (OAM cell including the control information) inputted from the client 12 over the ATM network 13 into an electric signal, and outputs the converted received cell data to the physical layer terminating unit 46′.

The cell data transmitted from the client 12 converted into an electric signal by the O/E converting unit 48′ is undergone the overhead process, the SONET (Synchronous Optical Network) terminating process or the SDH (Synchronous Digital Hierarchy) terminating process in the physical layer terminating process unit 46′, and outputted as an ATM cell to the ATM layer terminating unit 45′. The ATM layer terminating unit 45′ extracts an OAM cell as maintenance and operation cell from the ATM cell fed from the physical layer terminating process unit 46′.

The OAM cell analyzing unit 49′ analyzes the received OAM cell extracted as above by the ATM layer terminating unit 45′, and outputs a result of the analysis to the server-side control information processing unit 25. Particularly, the OAM cell analyzing unit 49′ analyzes source information control information included in the extracted OAM cell, and outputs a result of the analysis to the server-side control information processing unit 25.

The control information analyzed by the OAM cell analyzing unit 49′ is notified to the access controlling unit 23a or the server selecting unit 23b of the video server 23 from the server-side control information processing unit 25, whereby the access controlling unit 23a or the server selecting unit 23b can transmit source information through the connection 16 on the basis of the control information transmitted from the client 12 (refer to FIGS. 3 and 6).

When receiving an OAM cell as control information from the client 12, the line terminating unit 24 and the server-side control information processing unit 25 mentioned above send back an OAM cell as a reception confirmation signal (acknowledge signal) thereof to the client 12.

Namely, the OAM cell producing unit 50′ is inputted control information (acknowledge signal, for example) that should be notified to the client 12 from the server-side control information processing unit 25 to generate an OAM cell 20 (refer to FIG. 3) on the basis of the control information. The generated OAM cell 20 is sent out together with other data cells to the physical layer terminating unit 46′ via the ATM layer terminating unit 45′.

Video information as source information fed from the hard disk 21-1 is transmitted to the client 12 via the video server 23 and the line terminating unit 24. During which, when the control information used to control the source information is received from the client 12, an OAM cell generated by the OAM cell producing unit 50′ is inserted into data cells constituting the above source information, and outputted to the client 12.

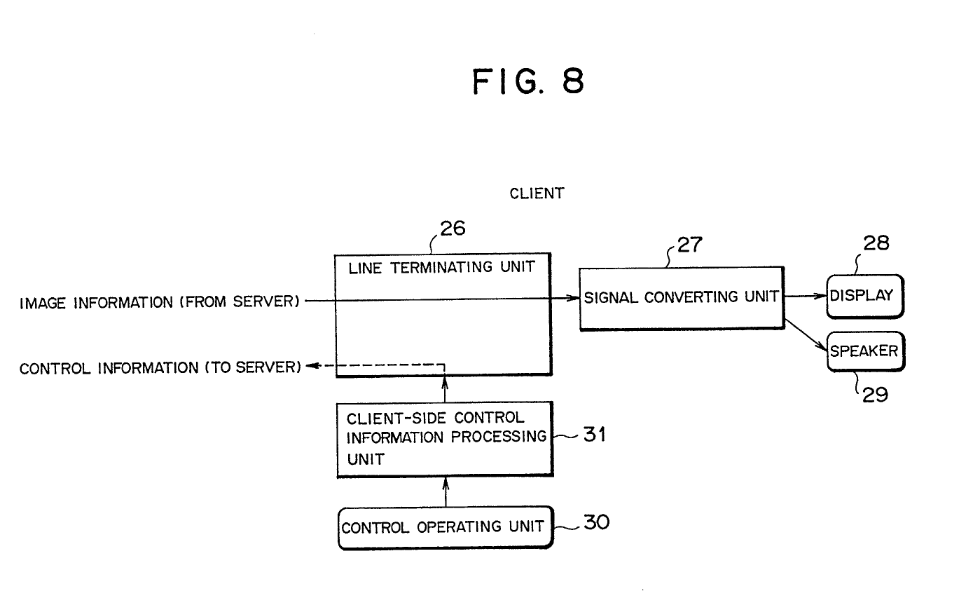

The client has a detailed structure shown in FIG. 8 when an attention is paid on a source information receiving function and a control information transmitting function to transmit control information to control source information. In FIG. 8, the functioning unit connected to the connection 17 and the connection 18 is omitted.

The client 12 has, as shown in FIG. 8, a line terminating unit 26, a signal converting unit 27, a display 28, a speaker 29, a control operating unit 30 and a client-side control information processing unit 31.

The line terminating unit 26 terminates the connection 16 set between the client 12 and the server 11 over the ATM network 13. In concrete, the line terminating unit 26 receives source information data transmitted from the server 11, besides transmitting control information used to control source information fed from the client-side control information processing unit 31 described later to the server 11 through the above connection 16.

The signal converting unit 27 decodes an MPEG2 (Motion Picture Image Coding Experts Group-2) signal or regenerates an NTSC (National Television System Committee) signal of the source information data as digital information received by the line terminating unit 26, thereby converting the signal into an image signal which can be regenerated in the display 28 or a voice signal which can be regenerated in the speaker 29.

The control operating unit 30 conducts a control on the source information received by the server 11 and regenerated by the display 28 and the speaker 29, which is configured with, for example, a remote controller.

The client-side control information processing unit 31 analyzes operation information fed from the control operating unit 30 to generate control information corresponding to the operation information. The generated control information is accommodated in a maintenance and operation cell in the line terminating unit 26 to be transmitted to the server 11.

The control operating unit 30, the client-side control information processing unit 31 and the line terminating unit 26 mentioned above have a function as a control information generating-transmitting unit for generating control information to control source information transmitted from the server 11, accommodating the control information in an OAM cell 20 (maintenance and operation cell; refer to FIG. 3) as a fixed length cell for control information and outputting the control information through the connection 16 for transmitting source information.

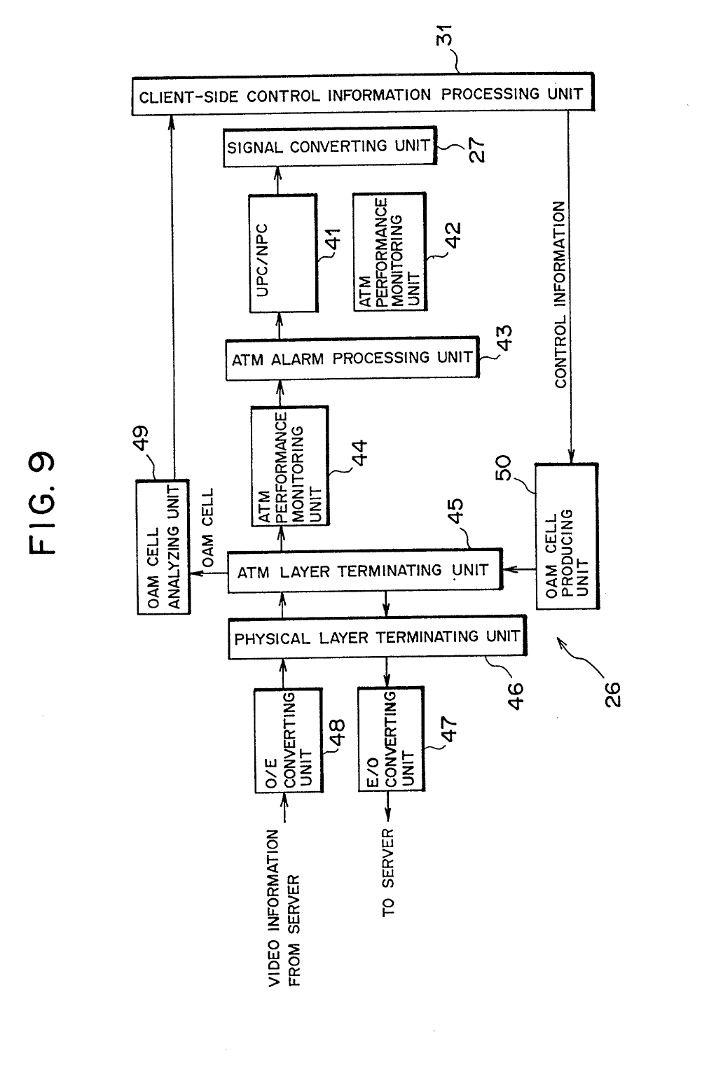

The line terminating unit 26 of the above client 12 has, as shown in detail in FIG. 9, a cell flow rate controlling unit (UPC/NPC) 41, an ATM performance monitoring unit 42, an ATM alarm processing unit 43, an ATM performance monitoring unit 44, an ATM layer terminating unit 45, a physical layer terminating unit 46, an E/O converting unit 47, an O/E converting unit 48, an OAM cell analyzing unit 49 and an OAM cell producing unit 50, which are similar to those of the above line terminating unit 24 in the server 11.

The O/E converting unit 48 converts an optical signal as cell data (OAM cell including control information) inputted from the client 12 over the ATM network 13 into an electric signal, and outputs it to the physical layer terminating unit 46.

The E/O converting unit 47 converts an electric signal as cell data (control information) fed from the physical layer terminating unit 46 into an optical signal, and transmits it to the server it over the ATM network 13.

The physical layer terminating unit 46 conducts the overhead process, the SONET (Synchronous Optical Network) terminating process or the SDH (Synchronous Digital Hierarchy) terminating process on the received cell data fed from the O/E converting unit 48 and sends it to the ATM layer terminating unit 45, besides conducting the overhead process, the SONET (Synchronous Optical Network) terminating process or the SDH (Synchronous Digital Hierarchy) terminating process on transmit cell data (source information and control information) fed from the ATM layer terminating unit 45 and sending it to the O/E converting unit 47.

The ATM layer terminating unit 45 extracts data cells as ATM cells and an OAM cell (maintenance operation cell) from the received cell data fed from the physical layer terminating unit 46, besides being inputted the transmit data fed from the ATM performance monitoring unit 44 to generate data cells as ATM cells, inserting an OAM cell fed from the OAM cell producing unit 50 described later into the generated data cells and sending the cells to the physical layer terminating unit 46.

Each of the ATM performance monitoring units 42 and 44 processes a performance management cell as an OAM cell. The ATM alarm processing unit 43 is inputted data from the ATM performance monitoring unit 42 to process a fault management cell and an activation/deactivation cell as OAM cells.

The cell flow rate controlling unit (UPC/NPC) 41 measures a flow rate of cells on the basis of cell data fed from the ATM alarm processing unit 43 to measures a parameter and the like of a traffic.

An ATM cell configuring video information and the like received from the above server 11 is received by the line terminating unit 26. In the line terminating unit 26, the ATM cell is undergone signal processes in the O/E converting unit 48, the physical layer terminating unit 46, the ATM layer terminating unit 45, the ATM performance monitoring unit 44, the ATM alarm processing unit 43 and the cell flow rate controlling unit 41, then converted into voice or image information by the signal converting unit 27.

The image information converted by the signal converting unit 27 is regenerated in the display 28, whereas the voice information is regenerated in the speaker 29. Whereby, the video information as source information transmitted from the server 11 can be regenerated in the display 28 or the speaker 29 of the client 12.

The OAM cell producing unit 50 is inputted source control information that should be notified to the server 11 from the above-mentioned client-side control information processing unit 31 to generate an OAM cell 20 (refer to FIG. 3) for source information control. The generated OAM cell is inserted in another cell in the ATM layer terminating unit 45, and sent to the physical layer terminating unit 46.

When a user operates the control operating unit 30, source control information generated by the OAM cell producing unit 50 is undergone signal processes in the client-side control information processing unit 31, the OAM cell producing unit 50, the ATM layer terminating unit 45, the physical layer terminating unit 46 and the E/O converting unit 47 of the line terminating unit 26, then transmitted in a format of OAM cell to the server 11 through the connection 16.

When the client 12 transmits an OAM cell including control information to the server 11, the line terminating unit 26 of the client 12 receives an OAM cell 20 as a reception confirmation signal (acknowledge signal) to the OAM cell from the server 11.

The OAM cell analyzing unit 49 analyzes the received OAM cell 20 extracted by the ATM layer terminating unit 45, and outputs a result of the analysis to the client-side control information processing unit 31. If the result of the analysis on the OAM cell 20 indicates a reception confirmation signal to the OAM cell 20 as a fixed length cell for control information transmitted from its own client 12 to the server 11, for example, the OAM cell analyzing unit 49 notifies that effect to the client-side control information processing unit 31.

The above OAM cell 20 as control information to be transmitted from the client 12 to the server 11 is transmitted through the same connection as the connection 16 for transmitting data cells from the server 11 to the client 12.

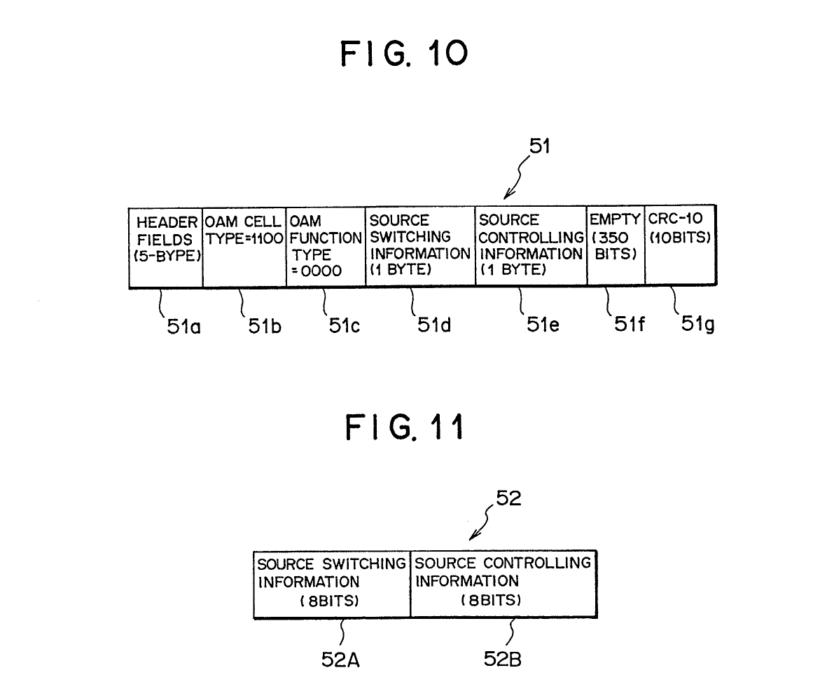

As the above OAM cell for source information control generated in the OAM cell producing unit 50, it is possible to set an exclusive OAM cell 51 for source information control in a format different from that of a data cell as a fixed length cell for source information as shown in FIG. 10, for example.

The OAM cell 51 shown in FIG. 10 has a header information regions 51a of 5 bytes, a region 51b of 4 bits in which OAM cell type information (=11100) is stored, a region 51c of 4 bits in which OAM function type information (=0000) is stored, a region 51d of 1 byte in which source switching information is stored, a region 51e of 1 byte in which source control information is stored, an empty region 51f of 350 bits and a CRC-10 region 51g of 10 bits.

The region 51d is a region for holding information used to switch source information, that is, a program that should be provided to the user, in which a value “0” indicating that there is no channel switching by the video server 23, a value “1” indicating a switching to a channel of movies, a value “2” indicating a switching to a channel of a menu screen, a value “3” indicating a switching to a channel of sports, or a value “4” indicating a switching to a channel of news programs, for example, are held.

The region 51e is a region for holding control information for source information being currently received on the basis of an operation of the control operating unit 30 of the client 12, in which a value “0” indicating regeneration of source information, a value “1” indicating stop of source information, a value “2” indicating rewinding of source information or a value “3” indicating shuttling of source information, for example, are held.

With the above structure, the VOD system according to the first embodiment of this invention transmits (provides) video information (programs of movies, sports, news, etc., for example) as source information from the server 11 to the client 12, as shown in FIG. 3. In other words, the server 11 accommodates source information in ATM cells as fixed length cells for source information, and transmits the ATM cells to the client through the connection 16 in the ATM network 13.

When receiving the above video information over the ATM network 13, the client 12 converts a signal of the video information in the line terminating unit 26A and the signal converting unit 27, then regenerates the signal as image information and voice information in the display 28 and speaker 29, respectively.

In concrete, the ATM cell configuring video information fed from the server 11 is undergone signal processes in the O/E converting unit 48, the physical layer terminating unit 46, the ATM layer terminating unit 45, the ATM performance monitoring unit 44, the ATM alarm processing unit 43 and the cell flow rate controlling unit 41 of the line terminating unit 26, converted into an image signal or a voice signal in the signal converting unit 27, then regenerated in the display 28 or the speaker 29.

On the other hand, the client 12 transmits control information directing to switch a channel of, shuttle or rewind source information such as image information being now regenerated in the display 28 or the speaker 29 mentioned above to the server 11 through the same connection as the connection 16 for source information, whereby the server 11 can transmit (provide) desired source information according to the control information to the client 12.

In other words, the line terminating unit 26 of the client 12 generates control information used to control source information transmitted from the server 11, accommodates the control information in an OAM cell 51 as a fixed length cell for control information, and outputs the OAM cell 51 through the same connection as the connection 16 for transmitting source information, as shown in FIGS. 8 and 10.

For instance, the OAM cell producing unit 50 of the line terminating unit 26 is notified operation information from the control operating unit 30 via the client-side control information processing unit 31 to generate an OAM cell 51 including control information on the basis of the operation information, thereby generating control information used to control source information on the side of the client 12.

The generated OAM cell 51 is undergone signal processes in the ATM layer terminating unit 45, the SONET terminating unit 46 and the E/O converting unit 47, then notified to the server 11 through the connection 16.

When receiving the above OAM cell 51, the server 11 extracts and analyzes the control information included in the OAM cell 51, thereby transmitting source information on the basis of a result of the analysis on the control information to the client 12 through the above connection 16.

When the line terminating unit 24 of the server 11 receives the above OAM cell 51 including the control information used to control the source information, the OAM cell 51 is extracted through signal processes conducted in the O/E converting unit 48′, the physical layer terminating unit 46′ and the ATM layer terminating unit 45′.

The extracted OAM cell 51 is analyzed in the OAM cell analyzing unit 49′, and contents of the control are notified to the video server 23 via the server-side control information processing unit 25. The video server 23 controls source information on the basis of the contents of the control, then outputs the source information as transmit data to the line terminating unit 24. The line terminating unit 24 converts the transmit data fed from the video server 23 into data in the ATM cell format, then transmits the data to the client 12 through the connection 16.

In concrete, when the video server 23 is notified control information directing a switching of a channel of source information, the server selecting unit 23b activates the hard disk 21-1, 21-2, . . . or 21-n (the hard disk 21-1, for example) in which data corresponding to the channel to be switched to is stored, take out video information from the activated hard disk 21-1, then transmits the video information as desired source information according to the above control information to the client 12 via the access control unit 23a and the line terminating unit 24.

When the video server 23 is notified control information directing to regenerate or stop source information, the access control unit 23a outputs video information fed from the hard disk 21-1, 21-2, . . . or 21-n activated by the server selecting unit 23b to the line terminating unit 24, or temporarily holds the video information, thereby providing the video information according to the above direction given by the client 12.

When the video server 23 is notified control information directing to shuttle or rewind source information, the access controlling unit 23a controls a transfer rate of video information fed from the hard disk 21-1, 21-2, . . . or 21-n activated by the server selecting unit 23b, thereby providing the video information according to the above direction given by the client 12.

If the above connection 16 is VCC, any number among “000” through “011” is given to the PT in the header portion of data cell as information to discriminate an ATM cell (data cell) configuring video information from an OAM cell including operation information flowing through the connection 16, while “100” or “101” is given to the PT in the header portion of the OAM cell.

If the connection 16 is VPC, “3” or “4” in decimal code representation is given to VCI of an OAM cell as information to discriminate an ATM cell (data cell) configuring video information from an OAM cell including operation information flowing through the connection 16, while any number among “32” through “4096” in decimal code representation is given to the VCI of a data cell.

Whereby, the ATM layer terminating unit 45 of the client 12 can identify a data cell configuring video information fed from the server 11 on the basis of information (PT or VCI) in the header portion, and the ATM layer terminating unit 45′ of the server 11 can identify an OAM cell including operation information fed from the client 12 on the basis of information (PT or VCI) in the header portion.

In the source information transmitting-receiving system according to the first embodiment of this invention, the control operation unit 30, the client-side control information processing unit 31 and the line terminating unit 26 in the client 12 can generate and output control information used to control source information, whereas the server-side control information processing unit 25 and the line terminating unit 24 can transmit source information based on control information fed from the client 12 to the client 12 through the connection 16. In consequence, only one connection is required to be set between the server 11 and the client 12 for one subscriber so that the network resources can be effectively used as compared with the system shown in FIG. 34. It is further possible to largely diminish a burden (charge) on the user.

Still further, it becomes unnecessary to establish a plurality of connections upon connection establishment, whereby a time required from when the user starts using to when the connection establishes can be shortened. This largely contributes to improvement of the service.

(b1) Description of Modification of First Embodiment

In the above embodiment, the OAM cell producing unit 50 of the line terminating unit 26 generates and transmits an OAM cell 51 exclusive for source information control as a fixed length cell for control information. However, this invention is not limited to this example. It is alternatively possible that the OAM cell producing unit 50 of the line terminating unit 26 writes control information in a specific OAM cell including another maintenance and operation information so that the maintenance and operation cell including another maintenance and operation information can be used as the above fixed length cell for control information. This modification can also realize the same effect as the above first embodiment.

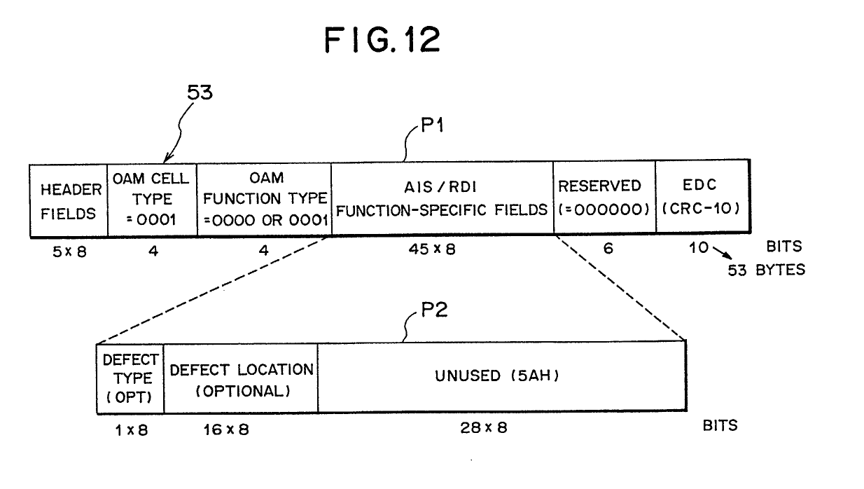

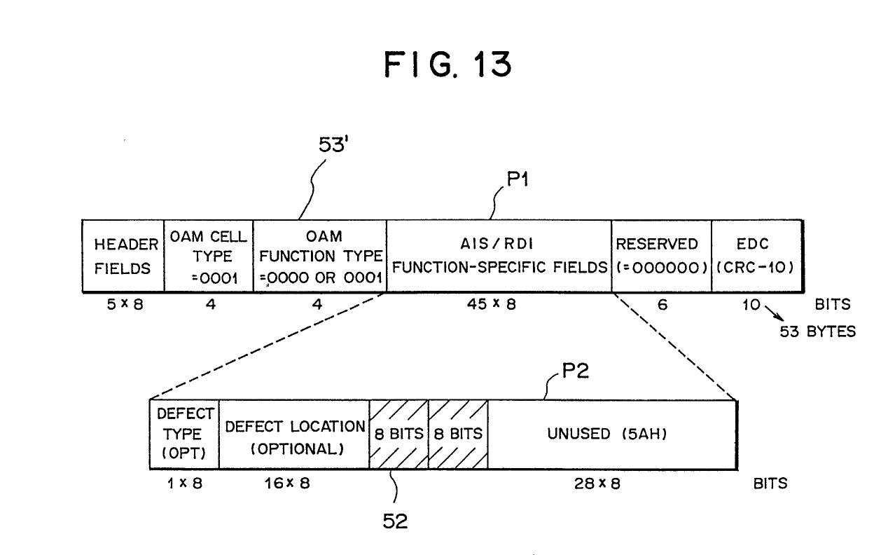

In concrete, the OAM cell producing unit 50 in the line terminating unit 26 writes control information 52 configured with a source switching information region 52A of 8 bits and a source control information region 52B of 8 bits shown in FIG. 11 in an unused region in an AIS/RDI region P1 in a Fault Management Cell 53 as an OAM cell as shown in FIG. 12, for example, whereby the Fault Management Cell 53 can be transmitted as a fixed length cell 53′ for control information shown in FIG. 13 to the server 11. Incidentally, a region indicated by slanted lines in FIG. 13 shows a region in which the control information 52 is written.

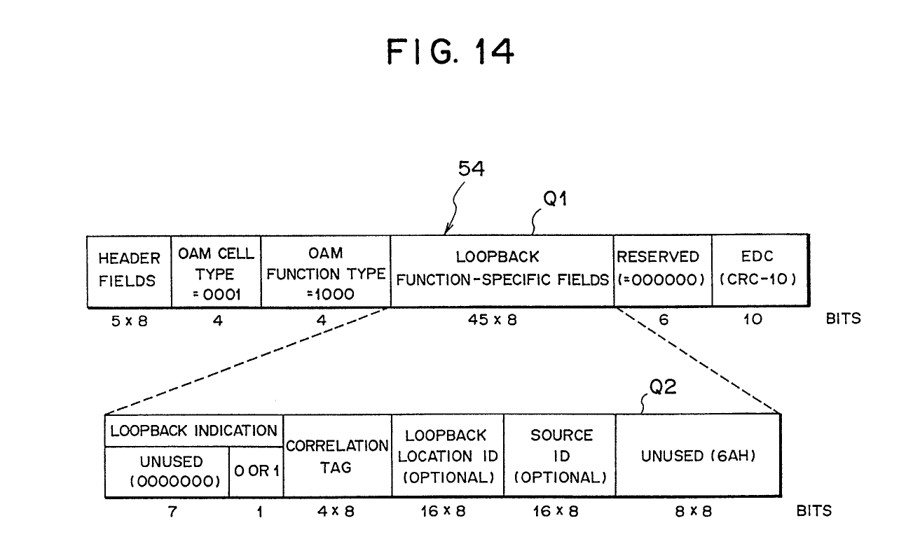

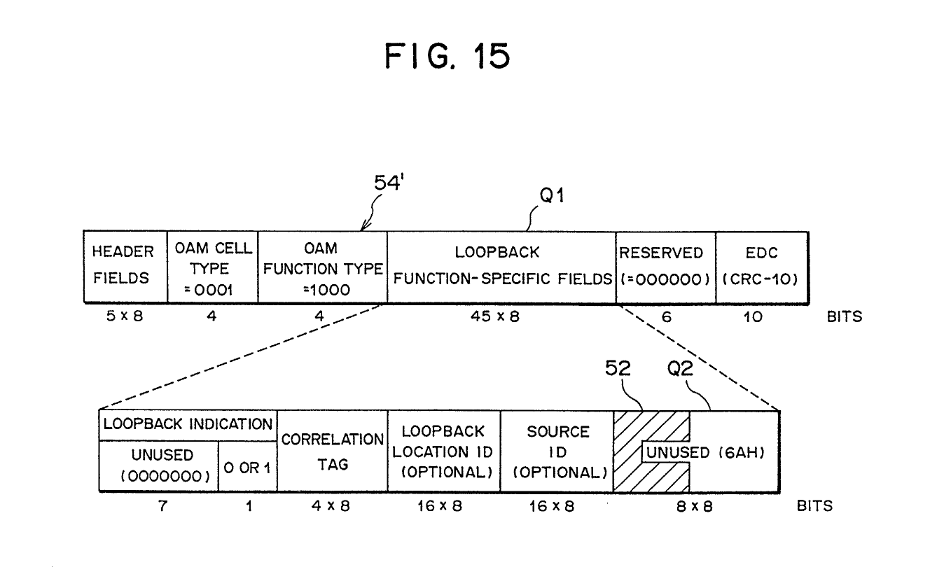

Alternatively, the OAM cell producing unit 50 writes the above control information 52 shown in FIG. 11 in an unused region Q2 in a Loopback Function Specific region Q1 in a Loopback Fault Management Cell 54 as an OAM cell shown in FIG. 14, for example, whereby the Loopback Fault Management Cell 54 can be transmitted as a fixed length cell 54′ for control information shown in FIG. 15 to the server 11. Incidentally, a region indicated by slanted lines is a region in which the control information 52 is written.

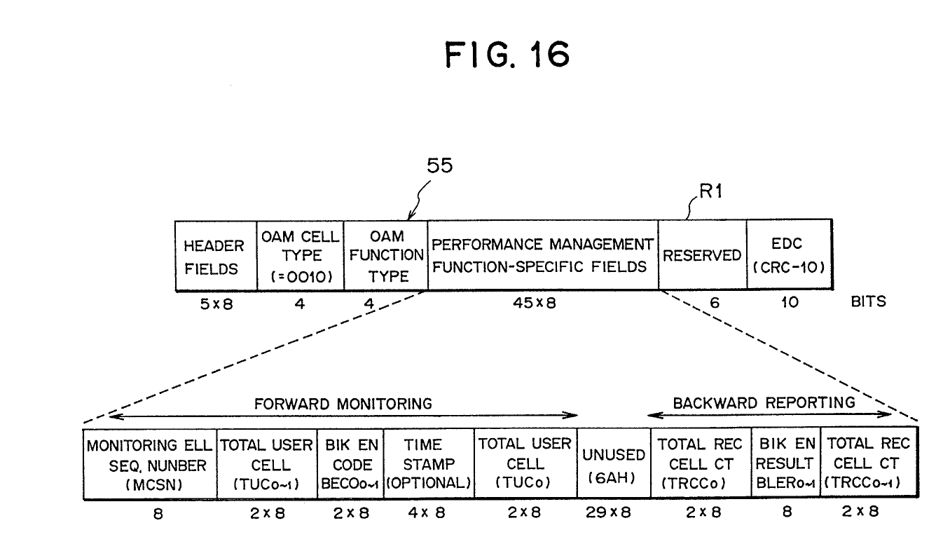

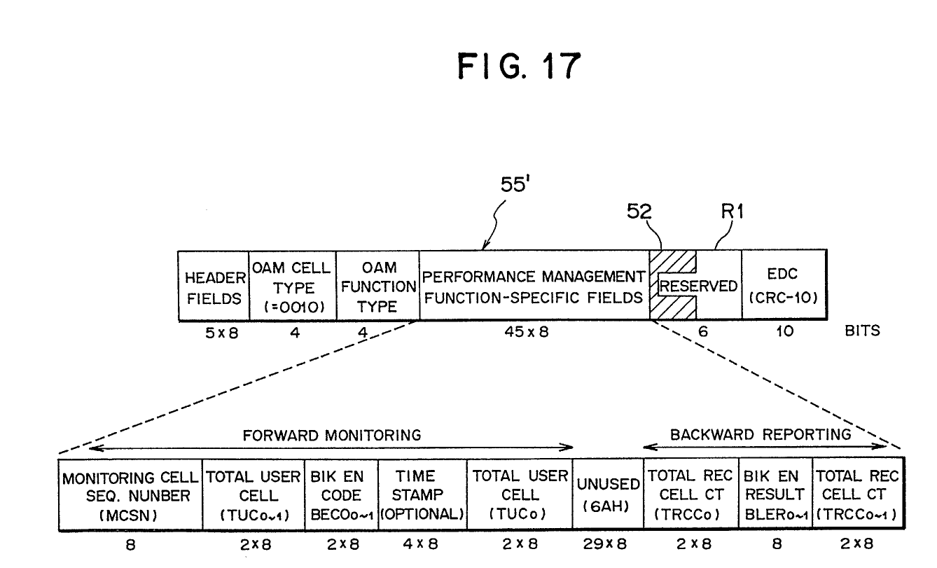

Similarly, the OAM cell producing unit 50 writes the above control information 52 shown in FIG. 11 in a Reserved region R1 in a Performance Management cell 55 as an OAM cell shown in FIG. 16, for example, whereby the Performance Management cell 55 can be transmitted as a fixed length cell 55′ for control information shown in FIG. 17 to the server 11. Incidentally, a region indicated by slanted lines is a region in which the control information 52 is written.

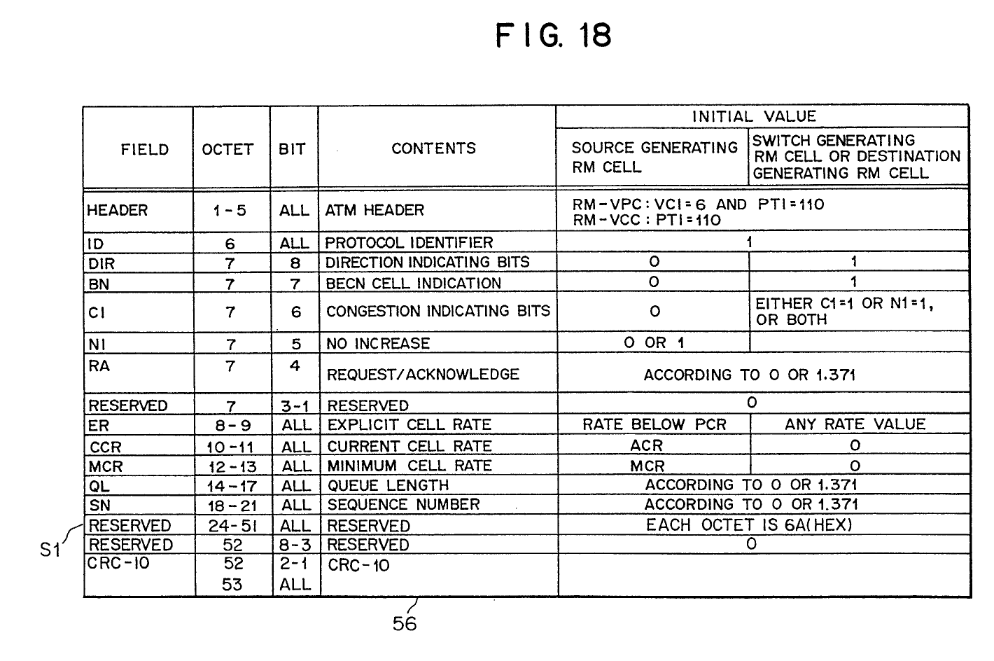

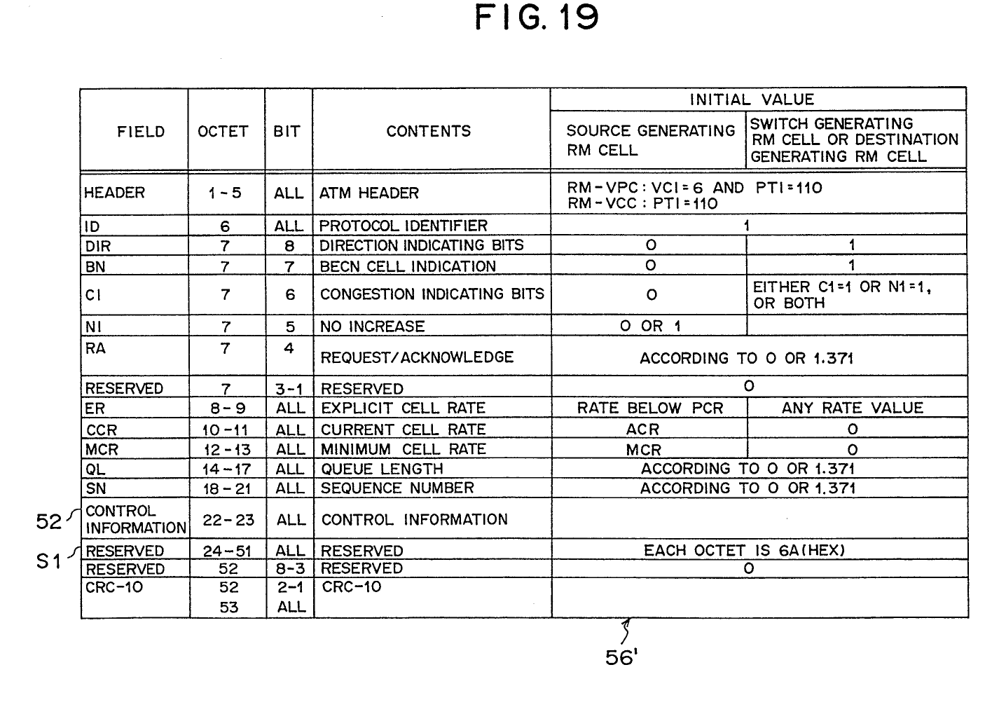

Still further, the OAM cell producing unit 50 writes the above control information 52 shown in FIG. 11 in a Reserved Region S1 at the 22nd to 23rd octets from the lead in a Resource Management Cell 56 as an OAM cell shown in FIG. 18, for example, whereby the Resource Management Cell 56 can be transmitted as a fixed length cell 56′ for control information shown in FIG. 19 to the server 11.

The OAM cell can be configured with a maintenance operation cell (OAM cell) including another maintenance operation information so that it is possible to notify control information to the server 11 using the OAM cell. This modification can also realize the same effect as the first embodiment. It is also possible to use an existing OAM cell as an OAM cell to transmit control information without setting an exclusive OAM cell separately.

(c) Description of Second Embodiment

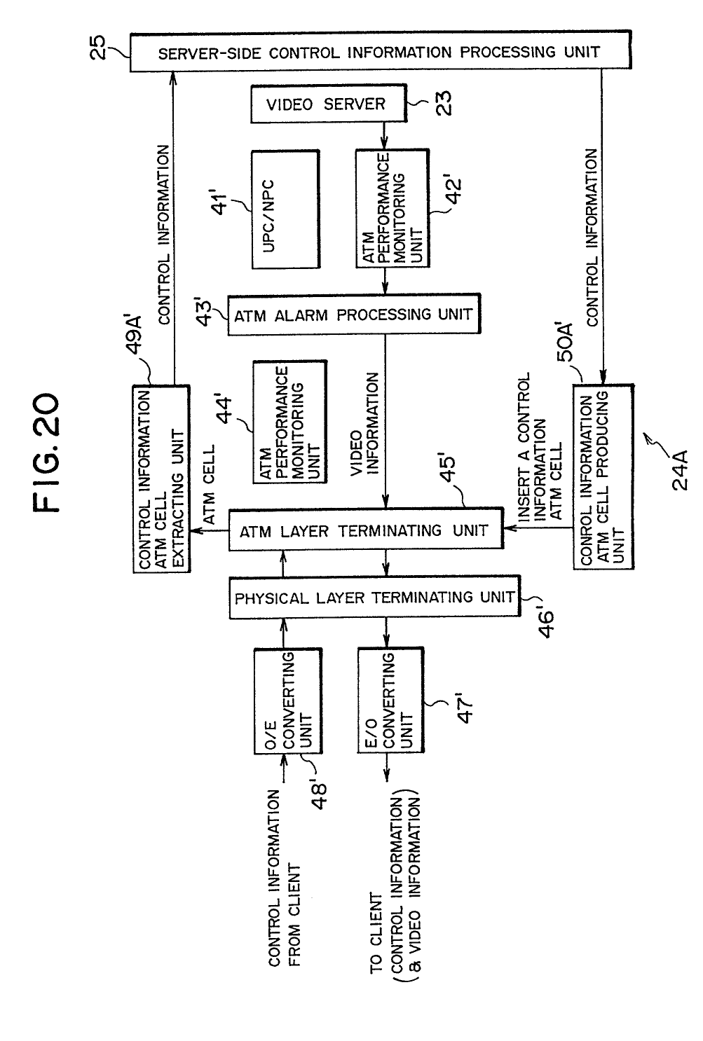

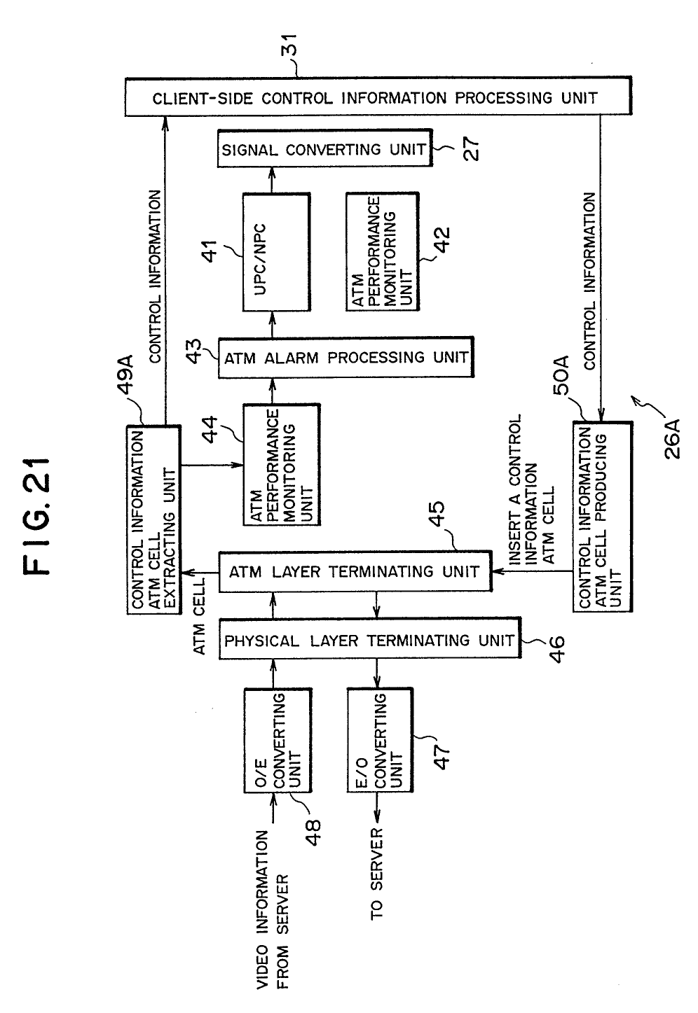

FIGS. 20 and 21 are block diagrams showing essential parts of a VOD system as a source information transmitting-receiving system according to a second embodiment of this invention. FIG. 20 is a block diagram showing a line terminating unit 24A of the server 11 according to this embodiment, whereas FIG. 21 is a block diagram showing a line terminating unit 26A of the client 12 according to this embodiment.

In the VOD system according to this embodiment, the line terminating unit 24A having a functioning unit for extracting control information on the side of the server 11 and the line terminating unit 26A having a functioning unit for generating control information on the side of the client 12 have different structures from those according to the above-described first embodiment (or the modification of the first embodiment). Another structures are basically the same (refer to FIGS. 7 and 8).

Namely, in the VOD system according to the second embodiment, a fixed length cell for control information is configured with, not an OAM cell, but an ATM cell (data cell) including control information generated by the client 12 in a data region (information field), dissimilarly to the above-described first embodiment (or the modification of the first embodiment).

The above control information has a format similar to that shown in FIG. 11 (refer to reference numeral 52), similarly to the modification of the above-described first embodiment. Incidentally, like reference characters in FIGS. 20 through 22 designate like or corresponding parts in FIGS. 7, 9 and 11 described before.

The line terminating unit 24A according to this embodiment of the server 11 has, as-shown in FIG. 20, a cell flow rate controlling unit (UPC/NPC) 41′, an ATM performance monitoring unit 42′, an ATM alarm processing unit 43′, an ATM performance monitoring unit 44′, an ATM layer terminating unit 45′, a physical layer terminating unit 46′ an E/O converting unit 47′, and an O/E converting unit 48′, similar to the line terminating unit (refer to reference numeral 24) according to the above-described first embodiment. The line terminating unit 24A further has a control information ATM cell extracting unit 49A′ and a control information ATM cell producing unit 50A′.

Video information as source information that should be transmitted fed from the hard disk 21-1 is inputted to the line terminating unit 24A via the video server 23, then outputted as data cells with optical signals to the client 12 on the basis of signal processes conducted in the ATM performance monitoring units 42′ and 44′, the ATM alarm processing unit 43′, the ATM layer terminating unit 45′, the physical layer terminating unit 46′ and the E/O converting unit 47′.

A received cell data transmitted from the client 12 converted into an electric signal by the O/E converting unit 48′ is undergone the overhead process, the SONET (Synchronous Optical Network) terminating process or the SDH (Synchronous Digital Hierarchy) terminating process in the physical layer terminating unit 46′, then extracted as an ATM cell in the ATM layer terminating unit 45′.

The control information ATM cell extracting unit 49A′ refers to a payload type PT of the received ATM cell extracted by the ATM layer terminating unit 45′ to extract an ATM cell in which control information for source information is included in the information field thereof, and outputs the control information in the ATM cell to the server-side control information processing unit 25.

By outputting the above control information to the server-side control information processing unit 25, the video server 23 can receive notification of the control information, and the access controlling unit 23a or the server selecting unit 23b can thereby transmit source information on the basis of the control information transmitted from the client 12 through the connection 16, similarly to the above-described first embodiment.

When receiving an ATM cell including control information transmitted from the client 12, the line terminating unit 24A and the server-side control information processing unit 25 mentioned above send back an ATM cell (data cell) as a reception confirmation signal (acknowledge signal) together with an ATM cell including the above video information to the client 12.

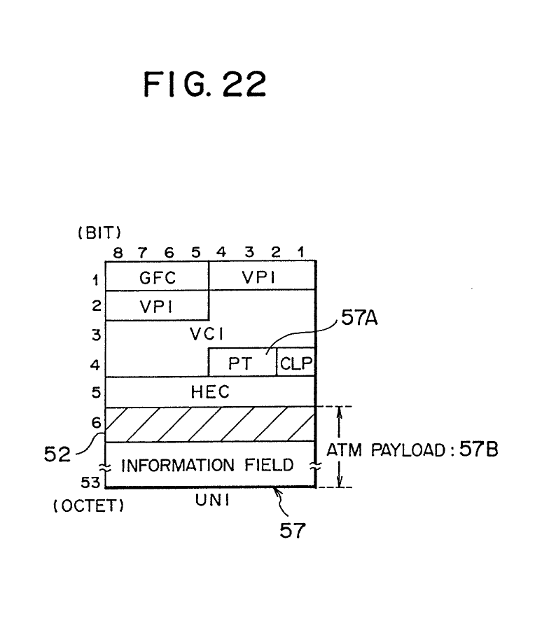

Namely, the control information ATM cell producing unit 50A′ is inputted control information (acknowledge signal, for example) that should be notified to the client 12 from the server-side control information processing unit 25 to produce an ATM cell in a format shown in FIG. 22 described later on the basis of the control information. The produced transmit ATM cell is inserted in other data cells by the ATM layer terminating unit 45′, sent to the physical layer terminating unit 46′, then outputted to the client 12 via the E/O converting unit 47′.

The line terminating unit 26A in the client 12 according to this embodiment has, as shown in FIG. 21, a cell flow rate controlling unit (UPC/NPC) 41, an ATM performance monitoring unit 42, an ATM alarm processing unit 43, an ATM performance monitoring unit 44, an ATM layer terminating unit 45, a physical layer terminating unit 46, an E/O converting unit 47 and and O/E converting unit 48, similarly to the line terminating unit (refer to reference numeral 26) according to the first embodiment. The line terminating unit 26A further has a control information ATM cell extracting unit 49A and a control information ATM cell producing unit 50A.

Similarly to the above-described first embodiment, video information transmitted from the above server 11 is received by the line terminating unit 26A. In the line terminating unit 26A, the video information is undergone signal processes in the O/E converting unit 48, the physical layer terminating unit 46, the ATM layer terminating unit 45, the ATM performance monitoring unit 44, an ATM alarm processing unit 43 and the cell flow rate controlling unit 41, then converted into voice or image information in the signal converting unit 27.

The image information configuring source information converted by the signal converting unit 27 is regenerated in the display 28. On the other hand, voice information also configuring the source information is regenerated in the speaker 29.

The control information ATM cell producing unit 50A is inputted source control information based on an operation of the control operating unit 30 via the client-side control information processing unit 31 to generate an ATM cell for source information control on the basis of the source control information. The generated ATM cell including control information is sent out together with other data cells via the ATM layer terminating unit 45, the physical layer terminating unit 46 and the E/O converting unit 47 through the connection 16.

Therefore, the control operating unit 30, the client-side control information processing unit 31 and the line terminating unit 26A described above have a function as a control information generating-transmitting unit for generating control information used to control source information transmitted from the server 11, accommodating the control information in an ATM cell as a fixed length cell for control information and outputting the ATM cell through the connection 16 for transmitting the source information.

When the client 12 transmits an ATM cell including control information to the server 11, the line terminating unit 26A of the client 12 receives an ATM cell as a reception confirmation cell (acknowledge signal) to the ATM cell from the server 11.

Namely, the control information ATM cell extracting unit 49A refers to a payload type PT of a received ATM cell extracted by the ATM layer terminating unit 45 to extract an ATM cell including control information, and outputs the extracted ATM cell to the client-side control information processing unit 31, while outputting an ATM cell not including the control information to the ATM performance monitoring unit 44.

If the control information of the extracted ATM cell is a reception confirmation signal to an ATM cell including control information having been transmitted from the client 12 to the server 11, this effect is notified to the client-side control information processing unit 31.

The ATM cell used to control source information generated by the above control information ATM cell producing unit 50A of the line terminating unit 26A or the ATM cell producing unit 50A′ of the line terminating unit 24A may be set as an ATM cell 57 in a format shown in FIG. 22, for example.

As shown in FIG. 22, source control information 52 (refer to FIG. 11) that should be notified to the above server 11 is written in leading 2 octets of an ATM payload 57B configuring an ATM cell 57.

In a payload type region (PT) 57A of the ATM cell 57 shown in FIG. 22, identification information (“111”, for example) indicating that the control information 52 is written in the ATM payload 57B of the ATM cell 57.

The control information ATM cell extracting units 49A′ and 49A of the above line terminating units 24A and 26A refer to contents written in the payload type region 57A to discriminate whether the ATM cell includes control information or not, thereby extracting the ATM cell 57.

In the VOD system with the above structure according to the second embodiment, the server 11 transmits (provides) video information (movie, sports or news programs or the like) as source information to the client 12 through the connection 16, similarly to the above-described first embodiment. In other words, the server 11 accommodates source information in ATM cells as fixed length cells for source information, and transmits the ATM cells to the client 12 over the ATM network 13.

When the client 12 receives the above video information over the ATM network 13, the line terminating unit 26 and the signal converting unit 27 converts the signal, and regenerates the signal in the display 28 or the speaker 29.

In concrete, an ATM cell configuring video information transmitted from the server 11 is undergone signal processes in the O/E converting unit 48, the physical layer terminating unit 46, the ATM layer terminating unit 45, the control information ATM cell extracting unit 49A, the ATM performance monitoring unit 44, the ATM alarm processing unit 43 and the cell flow rate controlling unit 41 of the line terminating unit 26A shown in FIG. 21, converted into an image signal or a voice signal in the signal converting unit 27, then regenerated in the display 28 or the speaker 29, on the side of the client 12.

On the other hand, the client 12 transmits control information directing to switch a channel of, shuttle, rewind, etc., source information being now regenerated in, for example, the display 28 or the speaker 29 mentioned above through the same connection as the connection 16 for source information, whereby the server 11 can transmit (provide) desired source information according to the control information to the client 12.

Namely, when an operation is conducted in the control operating unit 30 of the client 12 and contents of the operation is notified to the client-side control information processing unit 31, control information used to control the source information on the basis of the contents of the operation is outputted to the line terminating unit 26A shown in FIG. 21.

The ATM cell producing unit 50A of the line terminating unit 26A produces an ATM cell 57 (refer to FIG. 22) on the basis of the control information inputted from the client-side control information processing unit 31, and outputs the ATM cell 57 through the same connection as the connection 16 for transmitting the source information. Meanwhile, the ATM cell 57 includes the control information 52 used to control the source information transmitted from the server 11 in the ATM payload 57B thereof, besides having the payload type region 57A for identifying that the ATM cell 57 is an ATM cell including the control information 52.

When receiving the above ATM cell 57, the server 11 extracts the control information included in the ATM cell 57, and transmits source information based on the control information to the client 12 through the above connection 16.

Namely, when the line terminating unit 24A of the server 11 receives the ATM cell, the ATM cell is extracted through signal processes in the O/E converting unit 48′, the physical layer terminating unit 46′ and the ATM layer terminating unit 45′ (in this stage, the ATM cell is not extracted as the ATM cell 57).

PT of the ATM cell extracted by the ATM layer terminating unit 45′ is analyzed by the control information ATM cell extracting unit 49A′, whereby the ATM cell 57 is extracted. Contents of the control directed by the control information included in the ATM cell 57 is notified to the video server 23 via the server-side control information processing unit 25.

The video server 23 controls the source information on the basis of the contents of the control fed from the control information ATM cell extracting unit 49A′, then outputs the source information as transmit data to the line terminating unit 24A. The line terminating unit 24A converts the transmit data fed from the video server 23 into data in the ATM cell format, then transmits the data to the client 12 through the connection 16.

In concrete, when the video server 23 is notified control information directing a channel switching of the source information, the server selecting unit 23b activates the hard disk 21-1, 21-2, . . . or 21-n (the hard disk 21-1, for example) in which data corresponding to a channel to be switched to is stored to take out video information from the hard disk 21-1, and transmits the video information as desired source information according to the above control information to the client 12 via the access controlling unit 23a and the line terminating unit 24A (refer to FIG. 6), similarly to the above-described first embodiment.

When the video server 23 is notified control information directing to regenerate or stop the source information, the access controlling unit 23a outputs video information fed from the hard disk 21-1, 21-2, . . . or 21-n activated by the-server selecting unit 23b outputs to the line terminating unit 24A, or temporarily holds the video information, thereby providing the video information according to the above direction from the above client 12.

When the video server 23 is notified control information directing to shuttle or rewind the source information, the access controlling unit 23a controls a transfer rate of video information fed from the hard disk 21-1, 21-2, . . . or 21-n activated by the server selecting unit 23b, thereby providing the video information according to the direction from the above client 12.

In the VOD system according to the second embodiment of this invention, the control operating unit 30, the client-side control information processing unit 31 and the line terminating unit 26A of the client 12 generate control information used to control source information and output the control information as an ATM cell, whereas the server-side control information processing unit 25 and the line terminating unit 24A transmit source information based on the control information transmitted from the client 12 to the client 12 through the connection 16. In consequence, only one connection is required to be set between the server 11 and the client 12 for one subscriber. This can realize a more effective use of the network resources as compared with the VOD system shown in FIG. 34, further largely decrease a burden (charge) on the user.

It becomes unnecessary to establish a plurality of connections upon connection establishement. This can shorten a time required from when the user starts using to when the connection establishes. This effect largely contributes to improvement of the service.

(d) Description of Third Embodiment

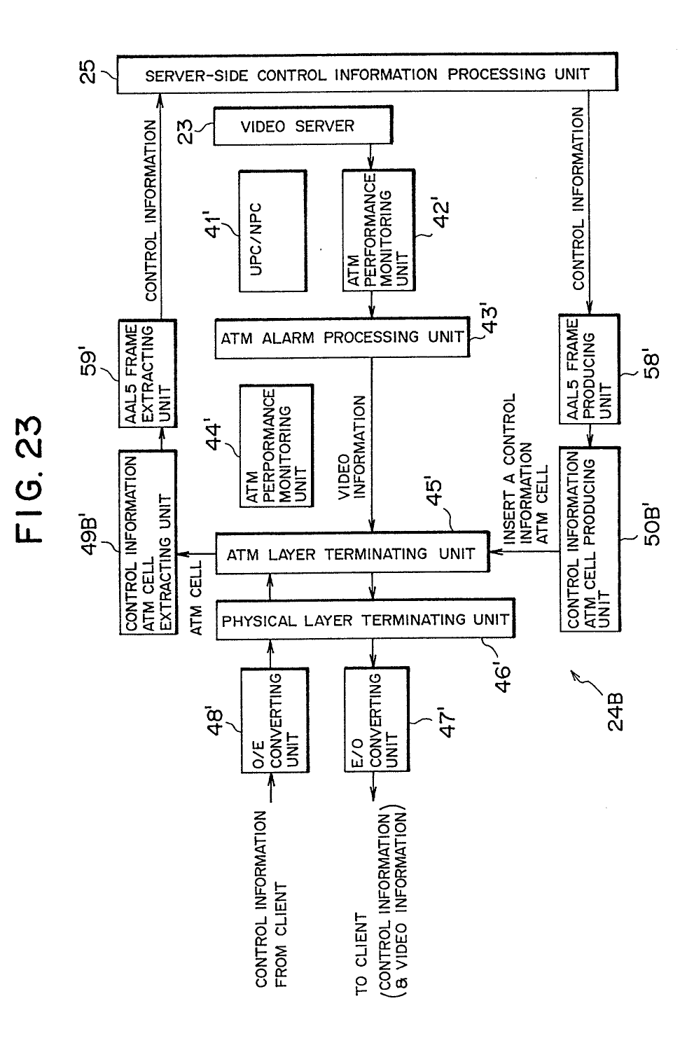

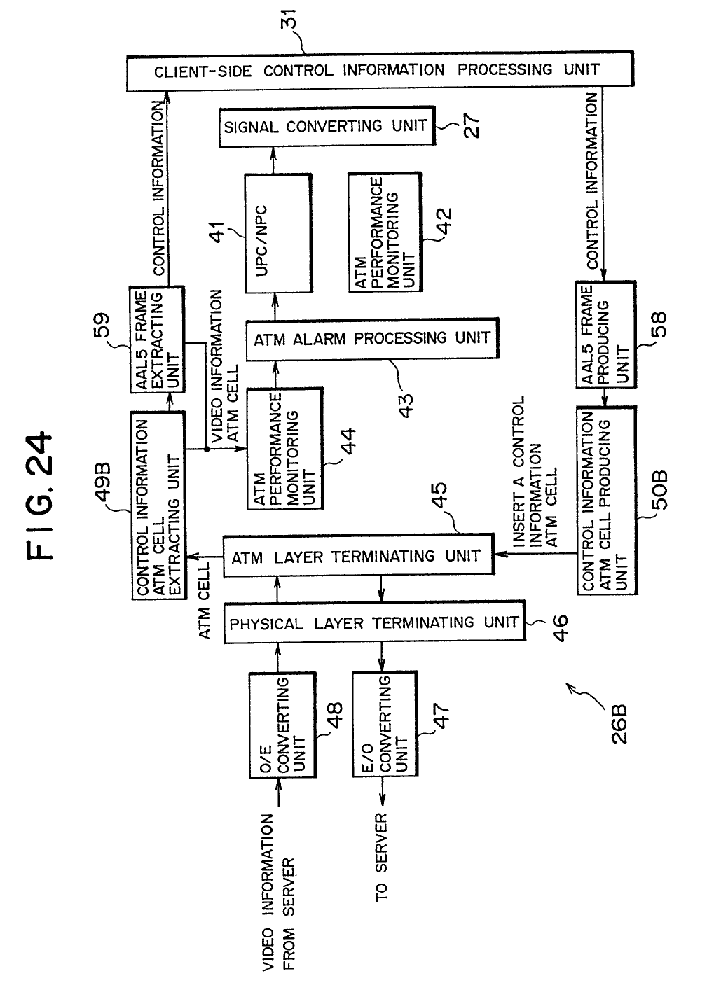

FIGS. 23 and 24 are block diagrams showing essential parts of a source information transmitting-receiving system according to a third embodiment of this invention. FIG. 23 is a block diagram showing a line terminating unit 24B of the server 11 according to this embodiment, whereas FIG. 24 is a block diagram showing a line terminating unit 26B of the client 12 according to this embodiment.

In the VOD system according to this embodiment, the line terminating unit 24B of the server 11 has, as shown in FIG. 23, an AAL5 frame producing unit 58′, an AAL5 frame extracting unit 59′, a control information ATM cell producing unit 50B′ and a control information ATM cell extracting unit 49B′, whereas the line terminating unit 26B of the client 12 has, as shown in FIG. 24, an AAL5 frame producing unit 58, an AAL5 frame extracting unit 59, a control information ATM cell producing unit 50B and a control information ATM cell extracting unit 49B, dissimilarly to the VOD system according to the above-described second embodiment. Another structure is basically the same as the second embodiment.

In the VOD system according to this embodiment, an exclusive higher layer which can handle information used to control source information received from the server 11 is set, besides an ATM cell generated by the higher layer is used as a fixed length cell for control information, dissimilarly to the first and second embodiments described above.

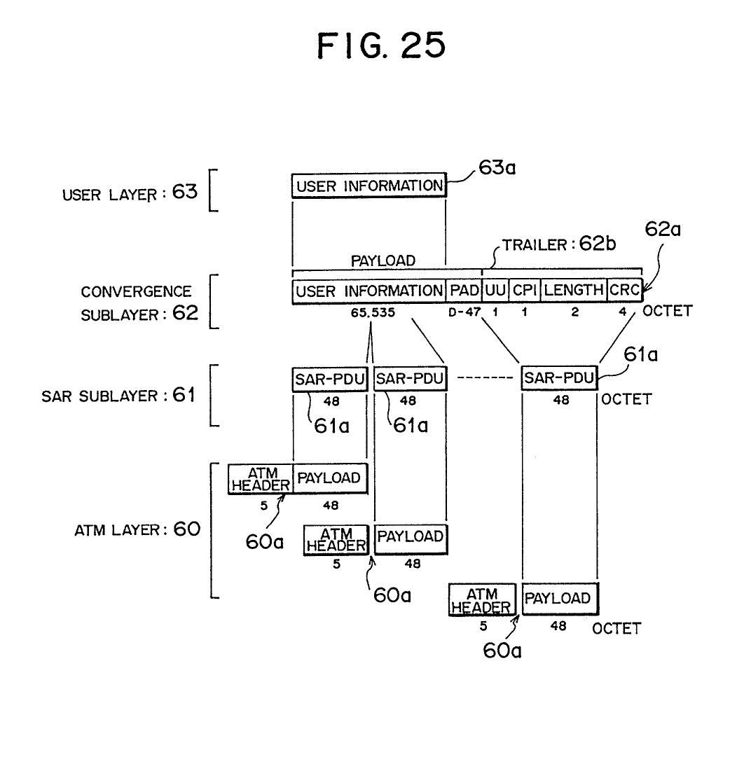

The AAL5 frame producing unit 58 functions as a higher layer setting unit for setting an exclusive higher layer which can handle control information to control source information fed from the client-side control information processing unit 31. The exclusive higher layer may be, for example, a user layer 63 higher than an ATM layer 60 as shown in FIG. 25, for example.

In other words, the AAL5 frame producing unit 58 of the line terminating unit 26B produces data 63a of the exclusive higher layer configured with the control information in the user layer 63 on the basis of the control information for controlling the source information fed from the client-side control information processing unit 31, then sets a frame 61a of AAL5 (ATM Adaptation Layer-5).

For instance, as shown in FIG. 25, by attaching a trailer 62b to the data 63a in Convergence Sublayer (CS) 62, the data 63a in the user layer 63 is temporarily converted into data 62a. The data 62a is divided into data 61a (SAR-PDU; SAR-Protocol Data Unit; data of AAL5) each of 48 octets in SAR sublayer (Segmentation and Reassembly Sublayer) 61.

In a UU region 62b-1 in the trailer 62b in the above Convergence Sublayer 62, there is set information (“FF” and the like, for example) indicating that control information is written in the user layer 63, whereby it is possible to discriminate the data from another data of AAL5.

A control information ATM cell producing unit 50B of the line terminating unit 26B packs the data 61a of AAL5 produced by the AAL frame producing unit 58 in a cell. In concrete, by attaching header information to each of the data 61a of AAL5, the data 61a is converted into an ATM cell 60a.

In the ATM cell 60a, identification information indicating that control information (“111”, for example) is written in the ATM payload of the ATM cell is written in the payload type region (PT), similarly to the ATM cell shown in FIG. 22.

Whereby, the control information ATM cell extracting unit 49B′ or 49B of the server 11 or the client 12 on the receiving side can discriminate whether the ATM cell includes control information or not by referring to contents written in the payload type region so as to extract the ATM cell 60a.

The converted ATM cell 60a, is undergone signal processes in the ATM layer terminating unit 45, the physical layer terminating unit 46 and the E/O converting unit 47, then transmitted to the server 11 through the same connection 16 as the connection 16 through which source information flows (refer to FIG. 3).

The control operating unit 30, the client-side control information processing unit 31 and the line terminating unit 26B described above have a function as a control information generating-transmitting unit for generating control information to control source information transmitted from the server 11, accommodating the control information in an ATM cell generated by the user layer 63, and outputting the ATM cell through the connection 16 for transmitting source information.

The control information ATM cell extracting unit 49B of the line terminating unit 26B refers to the payload type region of the header portion of an ATM cell extracted by the ATM layer terminating unit 46 received from the server 11, thereby extracting an ATM cell 60a including control information. As the control information included in the ATM cell 60a, there is information relating to reception confirmation to the control information for source information directed from the client 12 of its own, for example.

The AAL5 frame extracting unit 59 uses the ATM cell 60a extracted by the control information ATM cell extracting unit 49B to generate data 63a (the above reception confirmation information, for example) in the user layer 63 as a higher layer. The generated data 63a is outputted as control information to the server-side control information processing unit 25.

The AAL5 frame producing unit 58′ of the line terminating unit 24B in the server 11 sets an exclusive higher layer which can handle control information including information relating to reception confirmation to the control information included in the ATM cell 60a transmitted from the client 12, which basically has a function similar to that of the above AAL5 frame producing unit 58 of the line terminating unit 26B.

Likewise, the control information ATM cell producing unit 50B′ packs data of AAL5 produced by the AAL5 frame producing unit 58′ of the line terminating unit 24 in a cell, which basically has a function similar to that of the above control information ATM cell producing unit 50 in the line terminating unit 26B.

The control information ATM cell extracting unit 49B′ analyzes the payload type region (refer to the reference numeral 57A in FIG. 22) of a received ATM cell from the client 12, thereby extracting the ATM cell 60a including control information in the extracted ATM cell.

The AAL5 frame extracting unit 59′ of the line terminating unit 24B uses the ATM cell 60a extracted by the control information ATM cell extracting unit 49B′ to generate data 63a in the user layer 63 as a higher layer. The generated data 63a is outputted as control information to control source information to the server-side control information processing unit 25.

By outputting the above control information to the server-side control information processing unit 25, the video server 23 receives a notification of the control information, the access controlling unit 23a or the server selecting unit 23b can transmit source information on the basis of the control information transmitted from the client 12 through the connection 16, similarly to the above first and second embodiments.

In the VOD system according to the third embodiment of this invention with the above structure, the server 11 transmits (provides) video information (for example, a movie, sports or news program, etc.) as source information to the client 12 through the connection 16, similarly to the above first and second embodiments. Namely, the server 11 accommodates the source information in ATM cells as fixed length cells for source information and transmits the ATM cells to the clients 12 through the connection 16.

When the client 12 receives the above video information over the ATM network 13, the line terminating unit 26 and the signal converting unit 27 convert the signal, then regenerate the video information in the display 28 or the speaker 29 as image information or voice information.

In concrete, the ATM cell configuring the video information transmitted from the server 11 is undergone signal processes in the O/E converting unit 48, the physical layer terminating unit 46, the ATM layer terminating unit 45, the control information ATM cell extracting unit 49B, the AAL5 frame extracting unit 59B, the ATM performance monitoring unit 44, the ATM alarm processing unit 43 and the cell flow rate controlling unit 41 in the line terminating unit 26B, converted into an image signal or a voice signal in the signal converting unit 27, then regenerated in the display 28 or the speaker 29, as shown in FIG. 24.

On the other hand, the client 12 transmits to the server 11 control information directing to switch a channel of, shuttle or rewind, etc., the source information now being regenerated in, for example, the above display 28 or the speaker 29 through the same connection as the connection 16 for source information, whereby the server 11 can transmit (provide) desired source information according to the control information to the client 12.

Namely, when the control operating unit 30 of the client 12 is operated in order to control source information and contents of the operation is notified to the client-side control information processing unit 31, the control information to control the source information on the basis of the contents of the operation is outputted to the AAL5 frame producing unit 58 of the line terminating unit 26B shown in FIG. 24.

The AAL5 frame producing unit 58 of the line terminating unit 26B generates data 63a in the user layer 63 as an exclusive higher layer on the basis of the control information inputted from the client-side control information processing unit 31, then sets the frame 61a of AAL5 (ATM Adaptation Layer-5), as shown in FIG. 25.

The ATM cell producing unit 50B converts the frame 61a of AAL5 produced by the above AAL5 frame producing unit 58 into the ATM cell 60a by attaching header information thereto. The converted ATM cell 60a is processed in the ATM layer terminating unit 45, the physical layer terminating unit 46 and the E/O converting unit 47, then transmitted to the server 11 through the connection 16 in the ATM network 13.

When receiving the above ATM cell 60a, the server 11 can extract the control information included in the ATM cell 60a, then transmit the source information on the basis of the control information to the client 12 through the above connection 16.

Namely, when line terminating unit 24A of the server 11 receives the ATM cell 60a including the above control information for controlling the source information, the O/E converting unit 48, the physical layer terminating unit 46, the ATM layer terminating unit 45 and the control information ATM cell extracting unit 49B conduct signal processes to extract the ATM cell 60a.

The extracted ATM cell 60a is converted into the data 63a in the user layer 63 by the AAL5 frame extracting unit 59, and contents of the control indicated in the data 63a is notified to the video server 23 via the server-side control information processing unit 25.

The video server 23 controls the source information on the basis of the contents of the control, and outputs the source information as transmit data to the line terminating unit 24A. The line terminating unit 24A converts the transmit data supplied from the video server 23 into data in the ATM cell format, then transmits the data to the client 12 through the connection 16.

In concrete, when the video server 23 is notified control information directing a channel switching of the source information, the server selecting unit 23b activates the hard disk 21-1, 21-2, . . . or 21-n (the hard disk 21-1, for example) in which data corresponding to a channel to be switched to is stored to take out video information from the hard disk 21-1. The server 11 transmits the video information taken out to the client 12 via the access controlling unit 23a and the line terminating unit 24A as desired source information according to the above control information (refer to FIG. 6).

When the video server 23 is notified control information directing to regenerate or stop the source information, the access controlling unit 23a outputs video information supplied from the hard disk 21-1, 21-2, . . . or 21-n activated by the server selecting unit 23b to the line terminating unit 24A, or temporarily holds the video information, thereby providing the video information according to the control information transmitted from the client 12.

When the video server 23 is notified control information directing to shuttle or rewind the source information, the access controlling unit 23a controls a transfer rate of the video information supplied from the hard disk 21-1, 21-2, . . . or 21-n activated by the server selecting unit 23b, thereby providing the video information according to the above control information transmitted from the client 12.

In the VOD system according to the third embodiment of this invention, the control operating unit 30, the client-side control information processing unit 31 and the line terminating unit 26B of the client 12 set an exclusive higher layer to control source information, generate the ATM cell 60a for control information to control the source information from data in the higher layer, and transmit the ATM cell 60a, whereas the server-side control information processing unit 25 and the line terminating unit 24A transmit source information on the basis of the control information transmitted from the client 11 to the client 12 through the connection 16, similarly to the above first and second embodiments. In consequence, only one connection is required to be set between the server 11 and the client 12 for one subscriber. As a result, it is possible to efficiently use the network resources as compared with the VOD system shown in FIG. 34, and largely decrease a burden (charge) on the user.

Further, it becomes unnecessary to establish a plurality of connections upon connection establishment so that a time required from when the user starts using to when a connection is established can be shortened. As a result, the service can be largely improved.

(e) Description of Fourth Embodiment

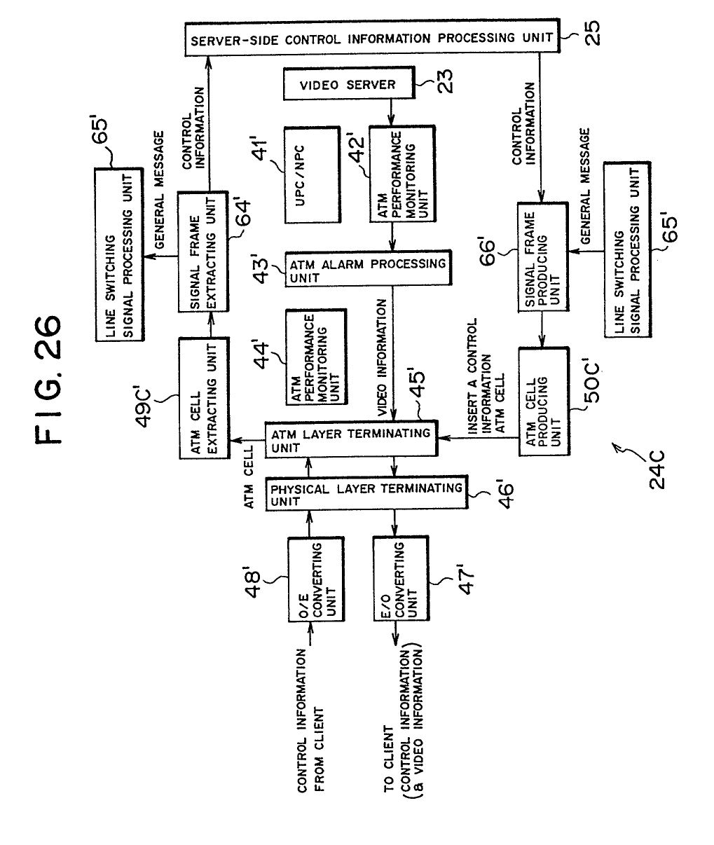

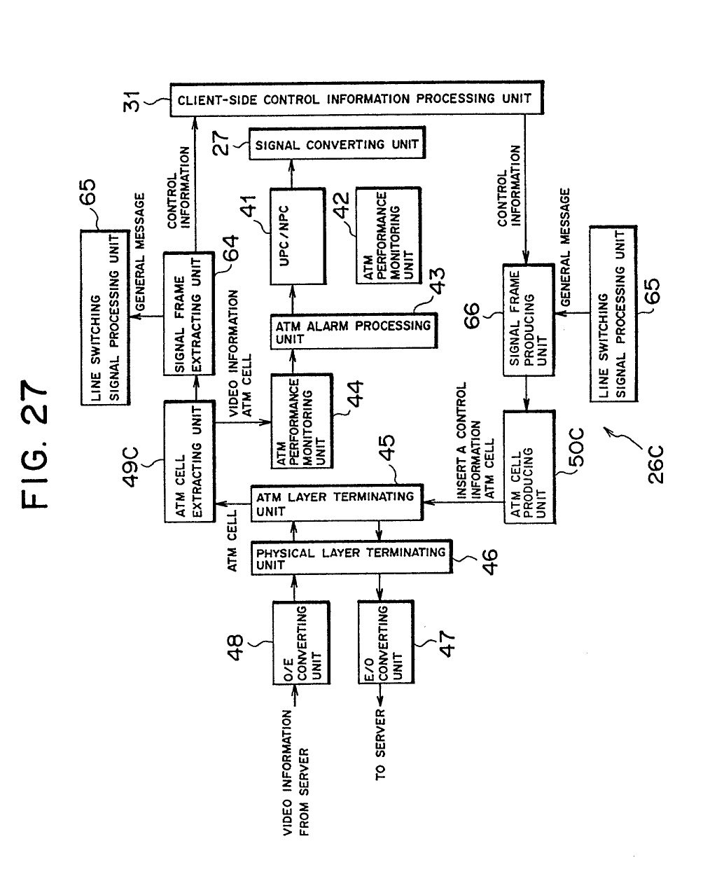

FIGS. 26 and 27 are block diagrams showing essential parts of a VOD system as a source information transmitting-receiving system according to a fourth embodiment of this invention. FIG. 26 is a block diagram showing a line terminating unit 24C of the server 11 according to the fourth embodiment, whereas FIG. 27 is a block diagram showing a line terminating unit 26C of the client 12 according to this embodiment.

In the VOD system according to this embodiment, the server 11 and the client 12 are connected by applying an SVC (Switched Virtual Channel) service. The client 12 accommodates control information to control source information in a signal for line switching and outputs the signal to the server 11. The server 11 transmits the source information to the client 12 on the basis of the control information accommodated in the signal for line switching transmitted from the client 12.

The line terminating unit 24C of the server 11 according to this embodiment has, as shown in FIG. 26, a control information ATM cell extracting unit 49C′, a signal frame extracting unit 64′, a line switching signal processing unit 65′, a control information ATM cell producing unit 50C′ and a signal frame producing unit 66′, in addition to a cell flow rate controlling unit 41′, an ATM performance monitoring unit 42′, an ATM alarm processing unit 43′, an ATM performance monitoring unit 44′, an ATM layer terminating unit 45′, a physical layer terminating unit 46′, an E/O converting unit 47′ and an O/E converting unit 48′ similar to those according to each of the above embodiments (refer to reference numerals 24, 24A and 24B).

The line terminating unit 26C of the client 12 according to this embodiment is a source information receiving apparatus for receiving source information from the server 11 over the ATM network 13 as a line switching network with an ATM cell as an information transmitting medium. As shown in FIG. 27, the line terminating unit 26C has a control information ATM cell extracting unit 49C, a signal frame extracting unit 64, a line switching signal processing unit 65, a control information ATM cell producing unit 50C and a signal frame producing unit 66, in addition to a cell flow rate controlling unit 41, an ATM performance monitoring unit 42, an ATM alarm processing unit 43, an ATM performance monitoring unit 44, an ATM layer terminating unit 45, a physical layer terminating unit 46, an E/O converting unit 47 and an O/E converting unit 48 similar to those according to each of the above (refer to reference numerals 26, 26A and 26B).

Incidentally, like reference characters in FIGS. 26 and 27 designate like or corresponding parts in FIGS. 7 and 9 described before.

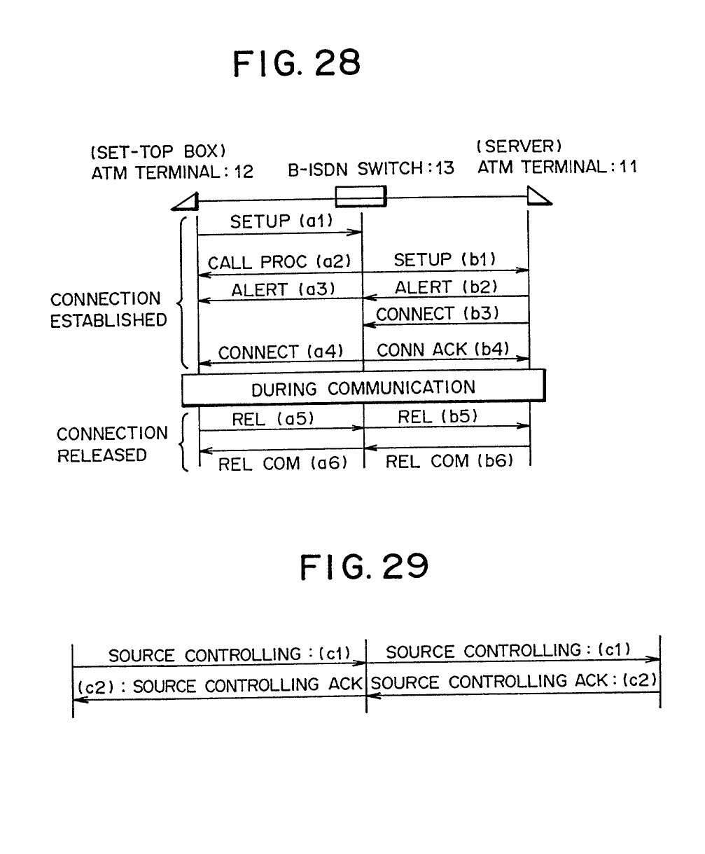

The line switching signal processing unit 65 of the line terminating unit 26C in the client 12 processes a general message signal used to switch the line. As shown in FIG. 28, for example, the line switching signal processing unit 65 processes signals (a1) through (a6) used to switch the line exchanged between an ATM terminal (set-top box) as the client 12 and the server 11 [or B-ISDN (Broadband-Integrated Services Digital Network) switch as the ATM network 13].

Namely, the line switching signal processing unit 65 generates a SETUP signal (a1) as a call setting signal or a REL signal (a5) as a call disconnecting signal, or receives a CALL PROC signal (a2), an ALERT signal (a3), a CONNECT signal (a4) or a REL COM signal (a6) from the server 11 or the B-ISDN switch.

In consequence, the above line switching signal processing unit 65 has a function as a line switching signal outputting unit for generating control information to control source information received from the server 11, besides accommodating the control information in a signal for line switching and outputting the signal for line switching from the client 12 to the server 11.

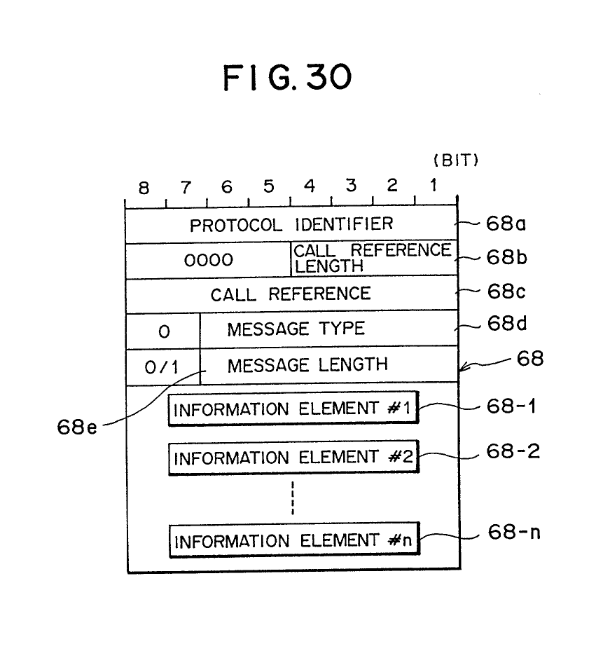

The signal frame producing unit 66 shown in FIG. 27 is inputted a general message signal [the SETUP signal (a1), for example] used to switch the line from the above line switching signal processing unit 65 to produce a signal frame 68 as shown in FIG. 30, for example, besides producing an exclusive message signal for source information control by accommodating the control information for controlling source information in the signal for line switching.

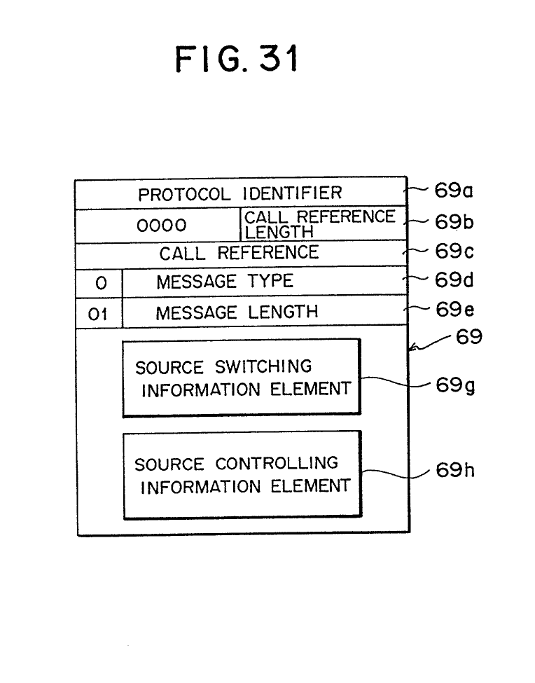

In concrete, the signal frame producing unit 66 creates a control signal frame 69 exclusive to source information control as shown in FIG. 31, for example, on the basis of source control information fed from the client-side control information processing unit 31.

Incidentally, the control signal frame 69 is transmitted as a source controlling signal (c1) from the client 12 to the server 11 in a state where the server 11 can provide source information to the client 12 (during a communication), as shown in FIG. 29, for example.

A format of the signal frame 68 has, as shown in FIG. 30, for example, a protocol discrimination 68c, a call reference length 68b, a call reference 68c, a message type 68d, a message length 68e and information elements 68-1 through 68-n in n types (n; an arbitrary integer equal to 1 or more).

A format of the control signal frame 69 has, as shown in FIG. 31, for example, a message type 69d, a message length 69e, a source switching information element 69g and a source control information element 69h different from those of the above general message signal, in addition to a protocol identifier 69a, a call reference length 69b and a call reference 69c similar to those of the above signal frame 68 indicating the general message signal.

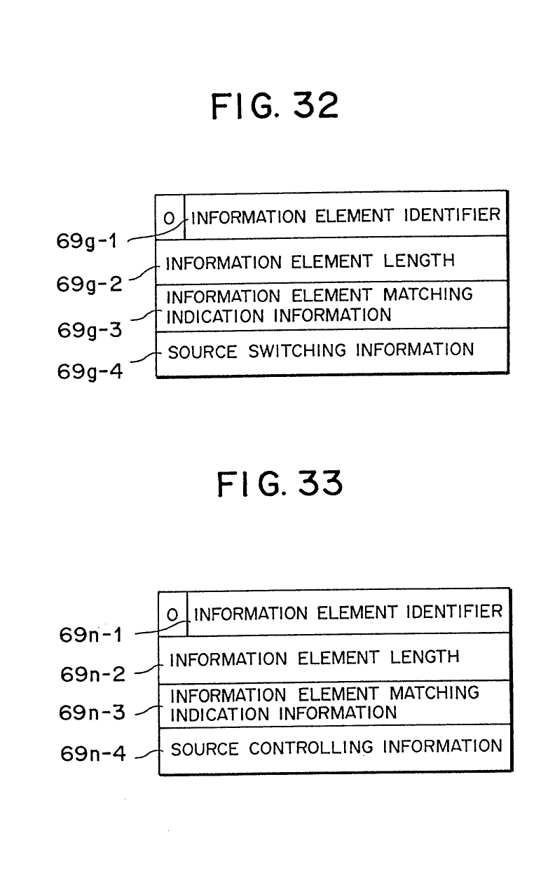

For instance, it is possible to set, for example, “7E” as information indicating that it is source control information in the message type 69d. The two information elements 69g and 69h have configurations shown in detail in FIGS. 32 and 33, respectively.

Namely, the source switching information element 69g is configured with, as shown in FIG. 32, a unique information element identifier 69g-1, an information element length information 69g-2, an information element matching indication information 69g-3 and source switching information 69g-4. The source switching information element 69h is configured with, as shown in FIG. 33, a unique information element identifier 69h-1, an information element length information 69h-2, an information element matching indication information 69h-3 and source control information 69h-4.

In concrete, “7E” and “7F” are set to the above unique information element identifiers 69g-1 and 69h-1, respectively, whereby it is possible to discriminate whether a relevant information element is for source control or source switching.

The control information ATM cell producing unit 50C transforms the signal frames 68 and 69 produced by the signal frame producing unit 66 into ATM cells on a signal channel (VPI=“0”, VCI=“5”). Information of the signal frames 68 and 69 transformed into the ATM cells is undergone signal processes in the ATM layer terminating unit 45, the physical layer terminating unit 46 and the E/O converting unit 46, then transmitted to the server 11 through the same connection 16 as the connection 16 through which source information flows (refer to FIG. 3).

The control information ATM cell extracting unit 49C extracts ATM cells on a signal channel (VPI=“0”, VCI=“5”) from received ATM cells (ATM cells transmitted from the server 11) extracted by the ATM layer terminating unit 45. The control information ATM cell extracting unit 49C outputs the extracted ATM cells on a signal channel to the signal frame extracting unit 64, while transferring ATM cells on a channel other than the signal channel to the ATM performance monitoring unit 44.

The signal frame extracting unit 64 extract an information element included in the signal frame on the basis of the ATM cells on the signal channel extracted by the control information ATM cell extracting unit 49C to regenerate the information element as a message signal. The signal frame extracting unit 64 outputs general message signals for line switching [signals (a2) through (a4) and (a6); refer to FIG. 28] among the regenerated message signals to the line switching signal processing unit 65. If the regenerated signal is a message signal indicating a reception confirmation signal to source controlling information transmitted from the client 12 of its own, the signal frame extracting unit 64 outputs the message signal as control information to the client-side signal processing unit 31.

In FIG. 26, the line switching signal processing unit 65′ of the line terminating unit 24C in the server 11 conducts a process relating to a general message signal for line switching, similarly to the line switching signal processing unit in the above client 12 (refer to reference numeral 65). For instance, the line switching signal processing unit 65′ processes signals (b1) through (b6) for line switching exchanged between the server 11 and the client 12 or the B-ISDN (Broadband-Integrated Services Digital Network) switch as the ATM network 13, as shown in FIG. 28, for example.

Namely, the line switching signal processing unit 65′ generates an ALERT signal (b2), a CONNECT signal (b3) or a REL COM signal (b6), or receives a SETUP signal (b1), a CONN ACK signal (b4) or a REL signal (b5), as shown in FIG. 28.

The signal frame producing unit 66′ is inputted a general message signal [the above ALERT signal (b2), for example] for line switching generated by the above line switching signal processing unit 65′ to produce the signal frame 68 similar to the above signal frame shown in FIG. 30 correspondingly to the message signal, besides producing the control signal frame 69 as shown in FIG. 31.

Incidentally, the control signal frame 69 is, as shown in FIG. 29, for example, transmitted as a reception confirmation signal (source control ACK) (C2) including a reception confirmation message to source control information transmitted from the client 12.

The control information ATM cell producing unit 50C′ shown in FIG. 26 transforms the signal frames 68 and 69 produced by the signal frame producing unit 66′ into ATM cells on a signal channel (VPI=“0”, VCI=“5”). Information of the signal frames transformed into the ATM cells is undergone signal processes in the ATM layer terminating unit 45′, the physical layer terminating unit 46′ and the E/O converting unit 47′, inserted into a flow of source information, then transmitted to the server 11 through the connection 16 (refer to FIG. 3).

The control information ATM cell extracting unit 49C′ shown in FIG. 26 extracts ATM cells on a signal channel (VPI =“0”, VCI=“5”) from received ATM cells (ATM cells transmitted from the client 12) extracted by the ATM layer terminating unit 45′, and outputs the extracted ATM cells on the signal channel to the signal frame extracting unit 64′.

The signal frame extracting unit 64′ extracts the signal frames 68 and 69 on the basis of the ATM cells on the signal channel extracted by the control information ATM cell extracting unit 49C′ to regenerate message signals.

The signal frame extracting unit 64′ outputs general message signals for line switching [the signal frame 68, the signals (b1), (b4) and (b5); refer to FIG. 28] among the regenerated message signals to the line switching signal processing unit 65′. If the regenerated message signal is a message signal (signal frame 69) indicating source control information transmitted from the client 12, the signal frame extracting unit 64′ outputs it as control information to the server-side signal processing unit 25.

The message signal indicating source control information regenerated by the signal frame extracting unit 64′ is notified to the access controlling unit 23a or the server selecting unit 23b of the video server 23 via the server-side control information processing unit 25, whereby the access controlling unit 23a or the server selecting unit 23b can transmit source information based on the control information transmitted from the client 12 through the connection 16 (refer to FIGS. 3 and 6).

In consequence, the hard disks 21-1 through 21-n, the disk controlling units 22-1 through 22-n, the video server 23, the line terminating unit 24C and the server-side control information processing unit 25 have a function as a source information transmitting unit for transmitting source information to the client 12 on the basis of control information accommodated in a signal for line switching transmitted from the client 12.

In the VOD system with the above structure according to the fourth embodiment of this invention, the server 11 and the client 12 are connected by applying the SVC (Switched Virtual Channel) service, where signal exchanges (refer to the signals (a1) through (a6), the signals (b1) through (b6)] are conducted as a procedure to set/release of the connection 16 for transmitting/receiving the above source information.

Namely, the client 12 outputs the SETUP signal (a1) to start exchanging signals for a call connection (establishing the connection 16) [refer to signals (a1) through (a4), and the signals (b1) through (b4)], whereas the client 12 receives the REL COM signal after outputting the REL signal (a5) as a disconnecting signal so as to disconnect the call (release the connection).

When the connection 16 is established by exchanging the above signals, the server 11 transmits (provides) video information (movie, sports or news program or the like) as source information to the client 12 through the connection 16, similarly to the first to third embodiments described before. Namely, the server 11 accommodates the source information in ATM cells as fixed length cells for source information and transmits the ATM cells to the client 12 through the connection 16.

In concrete, the video information to be transmitted from the server 11 is taken out from the hard disk 21-1, 21-2, . . . or 21-n shown in FIG. 6, then inputted to the line terminating unit 24C shown in FIG. 26 via the video server 23.

In the line terminating unit 24C, the source information fed from the video server 23 is undergone signal processes in the ATM performance monitoring unit 42, the ATM alarm processing unit 43, the ATM layer terminating unit 45, the physical layer terminating unit 46 and the E/O converting unit 47, and transmitted as ATM cells to the client 12 through the connection 16.

When the client 12 receives the above video information through the connection 16 in the ATM network 13 in a communicable state where the connection 16 is set, the line terminating unit 26 and the signal converting unit 27 convert the video information into signals, and regenerate the signals in the display 28 or the speaker 29.

Namely, the source information transmitted from the server 11 is received by the line terminating unit 26C in the client 12, undergone signal processes in the O/E converting unit 48, the physical layer terminating unit 46, the ATM layer terminating unit 45, the control information ATM cell extracting unit 49C, the AAL5 frame extracting unit 59, the ATM performance monitoring unit 44, the ATM alarm processing unit 43 and the cell flow rate controlling unit 41, converted into image signals or voice signals in the signal converting unit 47, then regenerated in the display 28 or the speaker 29.

On the other hand, the client 12 gives, to the server 11 through the same connection as the connection 16 for source information, control information directing to switch a channel of, shuttle or rewind the source information now being regenerated by the above display 28 or the speaker 29, whereby the server 11 can transmit (provide) desired source information according to the control information to the client 12.

Namely, while the connection 16 is established between the server 11 and the client 12, as shown in FIG. 29, the signal frame producing unit 66 produces the control signal frame 69 for source controlling. The line terminating unit 26C transmits the control signal frame 69 as source control information (c1) in the ATM cell format to the server 11, thereby giving control information as a direction relating to the source information.

When the server 11 receives the ATM cell configuring the above control signal frame 69, the signal frame extracting unit 64 of the line terminating unit 24C extracts the control information included in the ATM cell. The server-side control information processing unit 25 controls the source information being now provided to the client 12 on the basis of the extracted control information, then transmits the source information to the client 12 through the above connection 16.

In other words, when the line terminating unit 24A in the server 11 receives the ATM cell configuring the above control signal frame 69, the O/E converting unit 48′, the physical layer terminating unit 46′ and the ATM layer terminating unit 45′ conduct signal processes on the ATM cell to extract an ATM cell (the ATM cell is not extracted as an ATM cell configuring the control signal frame 69 in this stage).

The signal frame extracting unit 64 converts the extracted ATM cell into the original signal frames 68 and 69. After that, the the signal frame extracting unit 64 outputs the signal frame 68 to the line exchange signal processing unit 65 on the basis of contents of a control directed by the message types 68d and 69d of the signal frames 68 and 69, while outputting the frame 69 to the video server 23 via the server-side control information processing unit 25.

The video server 23 controls the source information according to the contents of the control described in the frame 69 on the basis of contents of the message type 69d and the information element identifiers 69g-1 and 69h-1 in the above frame 69, and outputs the source information as transmit data to the line terminating unit 24C. The line terminating unit 24C converts the transmit data from the video server 23 into data in the ATM cell format, then transmits the data to the client 12 through the connection 16.

In concrete, when the video server 23 is notified control information directing a channel switching of the source information, the server selecting unit 23b activates the hard disk 21-1, 21-2, . . . or 21-n (the hard disk 21-1, for example) in which data corresponding to a channel to be switched to is stored to take out video information from the hard disk 21-1, and transmits the video information as desired source information according to the above control information to the client 12 via the access controlling unit 23a and the line terminating unit 24A, similarly to the above first embodiment (refer to FIG. 6).

When the video server 23 is notified control information directing to regenerate or stop the source information, the access controlling unit 23a outputs video information supplied from the hard disk 21-1, 21-2, . . . or 21-n activated by the server selecting unit 23b to the line terminating unit 24A, or temporarily holds the video information, thereby providing video information on the basis of the above control information transmitted from the client 12.

When the server 23 is notified control information directing to shuttle or rewind the source information, the access controlling unit 23a controls a transfer rate of video information supplied from the hard disk 21-1, 21-2, . . . or 21-n activated by the server selecting unit 23b, thereby providing the video information on the basis of the above control information transmitted from the client 12.

In the VOD system according to the fourth embodiment of this invention, when the server 11 transmits source information to the client 12 through the connection 16 set in the ATM network 13 to which the SVC service is applied, the server 11 accommodates the source information in ATM cells and transmits them, whereas the client 12 generates the control signal frame 69 for controlling the source information received from the server 11 and outputs the control signal frame 69 in the ATM cell format to the server 11. The server 11 can thereby transmit the source information to the client 12 through the connection 16 on the basis of the control information included in the control signal frame 69 received in the ATM cell format from the client 12. Only one connection is therefore required to be set between the server 11 and the client 12 for one subscriber so that the network resources can be effectively used and a burden (charge) on the user can be largely diminished as compared with the VOD system shown in FIG. 34.

When establishing the connection, it becomes unnecessary to establish a plurality of connections. This can largely shorten a time required from when the user starts using to when the connection is established so that the service can be remarkably improved.

In this embodiment, the exclusive control signal frame 69 which is a signal for line switching in which control information is stored is used as a signal for controlling source information. However, this invention is not limited to this example. It is alternatively possible to use a signal which is a signal for line switching including another message signal in which control information is accommodated.

In other words, by attaching the above control information used to control source information to the message signal for line switching generally defined, the message signal can be used as a signal for controlling source information.

For instance, the above control information is added to the CALL PROC signal (a2) or the STATUS signal during communication (after the connection is established) or the like, whereby the signal can be a signal for controlling source information.

(f) Others

In the system for distributing images according to each of the above embodiments, this invention can be applied to a unidirectional connection. If this invention is applied to the unidirectional connection, the network resources can be effectively used much more.

What is claimed is:

1. A source information controlling method comprising the steps of:
accommodating source information in a fixed length cell for source information and transmitting the fixed length cell for source information when transmitting the source information from a source information transmitting apparatus to a source information receiving apparatus;
generating control information to control the source information transmitted from said source information transmitting apparatus by said source information receiving apparatus, accommodating said control information in a fixed length cell for control information and trasmitting said fixed length cell for control information through the same connection as a connection for transmitting said source information; and
transmitting said source information from said source information transmitting apparatus to said source information receiving apparatus through said connection on the basis of the control information transmitted from said source information receiving apparatus.

2. The source information controlling method according to claim 1, wherein a maintenance and operation cell for maintenance and operation upon transmitting and receiving data between said source information transmitting apparatus and said source information receiving apparatus is used as said fixed length cell for control information.

3. The source information controlling method according to claim 1, wherein a fixed length cell including the control information generated by said source information receiving apparatus in a data region thereof is used as said fixed length cell for control information.

4. The source information controlling method according to claim 1, wherein an exclusive higher layer being able to handle information to control the source information received from said source information transmitting apparatus is set, besides a fixed length cell generated by said higher layer is used as said fixed length cell for control information.

5. A source information controlling method comprising the steps of:
accommodating source information in a fixed length cell for source information and transmitting the fixed length cell for source information when transmitting said source information from a source information transmitting apparatus to a source information receiving apparatus over a line switching network;
generating control information to control the source information received from said source information transmitting apparatus in said source information receiving apparatus, accommodating said control information in a signal for line switching and outputting the signal for line switching to said source information transmitting apparatus; and
transmitting said source information from said source information transmitting apparatus to the source information receiving apparatus on the basis of the control information accommodated in the signal for line switching transmitted from said source information receiving apparatus.

6. A source information receiving apparatus for receiving source information from a source information trasmitting apparatus with a fixed length cell as an information transmitting medium comprising:
a control information generating-transmitting unit for generating control information to control the source information transmitted from said source information transmitting apparatus, accommodating said control information in a fixed length cell for control information and transmitting the fixed length cell for control information through the same connection as a connection for transmitting said source information.

7. The source information receiving apparatus according to claim 6, wherein said fixed length cell for control information is configured with a fixed length cell in a format different from a format of said fixed length cell for source information.

8. The source information receiving apparatus according to claim 6, wherein said fixed length cell for control information is configured with a maintenance and operation cell for maintenance and operation upon transmitting and receiving data between said source information transmitting apparatus and said source information receiving apparatus.

9. The source information receiving apparatus according to claim 8, wherein said maintenance and operation cell used as said fixed length cell for control information is configured with an exclusive maintenance and operation cell for controlling said source information.

10. The source information receiving apparatus according to claim 8, wherein said maintenance and operation cell used as said fixed length cell for control information is configured with a maintenance and operation cell including another maintenance and operation information.

11. The source information receiving apparatus according to claim 6, wherein said fixed length cell for control information is configured with a fixed length cell including the control information generated by said source information receiving apparatus in a data region thereof.

12. The source information receiving apparatus according to claim 6 further comprising a higher layer setting unit for setting an exclusive higher layer being able to handle information to control the source information received from said source information transmitting apparatus, and wherein said fixed length cell for control information is configured with a fixed length cell generated by said higher layer.

13. A source information receiving apparatus for receiving source information from a source information transmitting apparatus over a line switching network with a fixed length cell as an information transmitting medium comprising:
a line switching signal outputting unit for generating control information to control the source information received from said source information transmitting apparatus, accommodating said control information in a signal for line switching and outputting said signal for line switching from said source information receiving apparatus to said source information transmitting apparatus.

14. The source information receiving apparatus according to claim 13, wherein said signal for line switching outputted by said line switching signal outputting unit is configured with an exclusive message signal for controlling said source information.

15. The source information receiving apparatus according to claim 13, wherein said signal for line switching outputted by said line switching signal outputting unit is configured with a signal including another message signal.

16. A source information transmitting apparatus for transmitting source information to a source information receiving apparatus with a fixed length cell as an information transmitting medium comprising:
a source information transmitting unit for transmitting said source information to said source information receiving apparatus through a connection on the basis of control information received through the same connection as said connection for transmitting said source information from said source information receiving apparatus.

17. A source information transmitting apparatus for transmitting source information to a source information receiving apparatus with a fixed length cell as an information transmitting medium comprising:
a source information transmitting unit for transmitting the source information to said source information receiving apparatus on the basis of control information accommodated in a signal for line switching transmitted from said source information receiving apparatus.

18. A source information transmitting-receiving system comprising a source information transmitting apparatus for transmitting source information with a fixed length cell as an information transmitting medium and a source information receiving apparatus for receiving the source information from said source information transmitting apparatus;
wherein said source information receiving apparatus including a control information generating-transmitting unit for generating control information to control the source information transmitted from said source information transmitting apparatus, accommodating said control information in a fixed length cell for control information and transmitting the fixed length cell for control information through the same connection as a connection for transmitting said source information; and
wherein said source information transmitting apparatus including a source information transmitting unit for transmitting said source information to said source information receiving apparatus through said connection on the basis of the control information transmitted from said control information generating-transmitting unit.

19. A source information transmitting-receiving system comprising a source information transmitting apparatus for transmitting source information with a fixed length cell as an information transmitting medium and a source information receiving apparatus for receiving the source information from said source information transmitting apparatus over a line switching network;
wherein said source information receiving apparatus including a line switching signal outputting unit for generating control information to control the source information received from said source information transmitting apparatus, accommodating said control information in a signal for line switching and outputting said signal for line switching from said source information receiving apparatus to said source information transmitting apparatus; and
wherein said source information transmitting apparatus including a source information transmitting unit for transmitting said source information to said source information receiving apparatus on the basis of the control information accommodated in the signal for line switching transmitted from said line switching signal outputting unit.
